(19) United States
(12) Patent Application Publication
(10) Pub. No.: US 2025/0302038 A1
(43) Pub. Date: Oct. 2, 2025

(54) BROAD SPECTRUM DISINFECTING COMPOSITIONS

(71) Applicant: ADVANCED PEROXIDE TECHNOLOGIES (APT) B.V., Hilversum (NL)

(72) Inventor: Ilja BOBBERT, Hilversum (NL)

(73) Assignee: ADVANCED PEROXIDE TECHNOLOGIES (APT) B.V., Hilversum (NL)

(21) Appl. No.: 19/089,598

(22) Filed: Mar. 25, 2025

(30) Foreign Application Priority Data
Mar. 26, 2024 (EP) 24166304.6
Jul. 22, 2024 (EP) 24189974.9
Oct. 23, 2024 (EP) 24208474.7

(51) Int. Cl. A01N 37/46; A01N 25/30; A01N 31/04; A01N 59/00; A01P 1/00

(52) U.S. Cl. CPC A01N 37/46; A01N 25/30; A01N 31/04; A01N 59/00; A01P 1/00

(57) ABSTRACT

A disinfecting composition includes: one or more acetate-containing solvents in a total amount of from 0.1 to 20 wt. %; from 0.1 to 15 wt. % of hydrogen peroxide; from 0.01 to 10 wt. % of one or more N-acylated amino acids or a salt thereof; from 0.2 to 20 wt. % of one or more surfactants selected from the group consisting of non-ethoxylated anionic surfactants and salts of a compound according to formula II, R²—(O—CH₂—CH₂)ₘ—O—SO₃⁻, wherein R² is C(8-18)alkyl and m is 2-6; and wherein the disinfecting composition has a pH of from 0.5 to 4.0. The disinfecting composition was shown to have broad antimicrobial activity, including against bacteria and viruses, as well as to have excellent material compatibility.

### FIELD OF THE INVENTION

The disclosure relates to disinfecting compositions, in particular disinfecting compositions suitable for use in broad-spectrum disinfection of a surface, particularly using pre-impregnated towelettes. The disclosure also relates to methods and uses in which the disinfecting compositions are used.

### BACKGROUND AND SUMMARY

Disinfecting compositions can be applied to a surface in a number of ways. For example, disinfecting compositions can be applied to a surface using a trigger sprayer, continuous sprayer, trigger foamer or with towelettes impregnated with the disinfecting composition. The use of towelettes for application of a disinfecting composition is especially desirable, as it is very convenient.

Disinfecting a surface with a disinfecting composition that has a broad spectrum efficacy is critically important because it is often unknown with which organisms a hard surface is contaminated. For instance, Candida auris and several small non-enveloped viruses are very hard-to-kill organisms, and pose a major threat to human health.

Furthermore, a short and practically realistic contact time is critically important to ensure compliance in daily disinfection routines. A contact time of at most 2 minutes is often desired, but (even) shorter contact times are preferred. However, only a few disinfecting compositions described in the literature are actually suitable for use in towelettes, have a broad spectrum antimicrobial efficacy and require a short contact time to disinfect a surface.

Another important aspect of a disinfectant composition is its effect on materials like plastics, metals, rubbers or glue. Many objects in healthcare environments are made of plastic or metal surfaces with rubber seals. It is important to effectively disinfect these objects or surfaces without causing damage to the object. Material compatibility with a wide spectrum of materials often used in healthcare settings is therefore also an important feature of a disinfectant.

WO 2008/071746 describes a composition for skin disinfection. It is said the composition can be in the form of an impregnated towelette. However, the compositions according to WO 2008/071746 are shown to be only active against Staphylococcus aureus, Salmonella thyphimurium, and Escherichia coli in suspension tests after three to five minutes. This is a narrow spectrum efficacy with relatively long contact times.

WO 2016/124764 describes a method for disinfecting surfaces, as well as compositions suitable for use in the method. It is said this composition can be in the form of an impregnated wipe. The compositions were shown to be active against Escherichia coli, Staphylococcus aureus and Enterococcus hirae. This is a narrow spectrum efficacy.

US 2019/0297881 describes a ready-to-use antimicrobial solution. The solution is free of percarboxylic acids and precursors thereof, bleaching agents and low molecular weight organic diamines. It is said the compositions in US 2019/0297881 can be used in the form of impregnated wipes. However, the compositions are shown to be active against Staphylococcus aureus in a quantitative disk carrier test method (ASTM E2917-02), which does not include any wiping or rubbing action and is, according to ASTM International, not suitable for testing germicide-soaked wipes.

The antimicrobial activity observed in suspension tests is generally higher than the antimicrobial activity observed in tests using towelettes (also known as “wet wipes”). Indeed, as shown in Example 4 herein, compositions according to e.g. US 2019/0297881 and WO 2008/071746 were found to be ineffective against S. aureus when applied using a towelette. Accordingly, when disinfecting compositions described in the literature discussed above are or would be applied using towelettes, longer contact times are or would be required. This is undesirable, as long contact times lead to misuse of the disinfecting composition, which, in turn, leads to insufficient disinfection and non-compliance.

Also, efficacy against only ‘easier-to-kill’ basic bacteria does not mean sufficient efficacy against harder-to-kill and clinically more relevant organisms, such as Candida auris or non-enveloped viruses.

There is a need in the art for improved disinfection compositions. Particularly, there is a need in the art for safe and effective disinfecting compositions that can successfully be applied to surfaces using towelettes, without requiring long contact times, with a broad spectrum of antimicrobial efficacy, and without negatively affecting the surfaces in healthcare settings. The present disclosure provides such disinfecting compositions.

The disinfecting compositions disclosed herein are capable of passing the United States' Environmental Protection Agency's tests for towelettes (Germicidal Towelette Method/AOAC Official Method 961.02 and ASTM E1053-20 as amended for towelettes). This test is very hard to pass, but is required to achieve a pesticide registration. Consequently, the disinfecting compositions disclosed herein meet the Environmental Protection Agency's requirements for pesticide registration.

Additionally, the disinfecting compositions disclosed herein are surprisingly compatible with a wide variety of surfaces. Material compatibility with a number of frequently used plastics, rubbers, metals and with stainless steel has been demonstrated. Moreover, the disinfecting compositions disclosed herein have a good odor, in contrast to certain composition described in the art. Even more, the disinfecting composition disclosed herein is surprisingly stable over long periods of time.

### BRIEF DESCRIPTION OF THE DRAWINGS

FIG. 1 shows the effect of disinfecting composition 15 on a strip of polycarbonate.

FIG. 2 shows the effect of disinfecting composition 15 on a strip of acrylic.

FIG. 3 shows the effect of disinfecting composition 15 on a strip of ABS.

FIG. 4 shows the effect of comparative disinfecting composition 42 on a strip of PMMA.

### DETAILED DESCRIPTION

The present disclosure relates to a disinfecting composition comprising:
a) one or more compounds according to formula I:

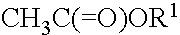

wherein R¹ is
   C(1-5)alkoxy-C(1-5)alkyl wherein the C(1-5)alkoxy is optionally substituted with one hydroxyl group or methyl ester,
   C(1-3)alkoxy-C(1-5)alkoxy-C(1-5)alkyl wherein the C(1-3)alkoxy is optionally substituted with one hydroxyl group or methyl ester,
   C(2-5)alkyl wherein the C(2-5)alkyl is substituted with one or two methyl esters and/or one or two hydroxyl groups,
   C(2-12)alkyl, in particular C(2-5)alkyl,
   C(2-12)alkenyl, in particular C(3-7)alkenyl,
   C(2-12)alkynyl, in particular C(3-7)alkynyl, or
   C(6)aryl-C(1-2)alkyl optionally substituted with one or more hydroxy, methoxy, amino, or C(1-3)alkyl groups,
and/or one or more compounds according to formula Ia:

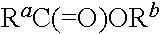

wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy,
in a total amount of from 0.1 to 20 wt. % (calculated on the total weight of the composition);
b) from 0.1 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition); and
d) one or more surfactants selected from the group consisting of non-ethoxylated anionic surfactants and salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition),
   wherein the disinfecting composition has a pH of from 0.5 to 4.0.

The present disclosure particularly relates to a disinfecting composition comprising:
a) one or more compounds according to formula I:

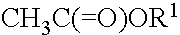

wherein R¹ is
   C(1-5)alkoxy-C(1-5)alkyl wherein the C(1-5)alkoxy is optionally substituted with one hydroxyl group or methyl ester,
   C(1-3)alkoxy-C(1-5)alkoxy-C(1-5)alkyl wherein the C(1-3)alkoxy is optionally substituted with one hydroxyl group or methyl ester,
   C(2-5)alkyl wherein the C(2-5)alkyl is substituted with one or two methyl esters and/or one or two hydroxyl groups, or
   C(2-5)alkyl, in a total amount of from 0.1 to 20 wt. % (calculated on the total weight of the composition);
b) from 0.1 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition); and
d) one or more surfactants selected from the group consisting of non-ethoxylated anionic surfactants and salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition),
   wherein the disinfecting composition has a pH of from 0.5 to 4.0.

### Compounds According to Formula I

The disinfecting composition comprises a compound according to formula I, CH₃C(═O)OR¹, wherein R¹ is
C(1-5)alkoxy-C(1-5)alkyl wherein the C(1-5)alkoxy is optionally substituted with one hydroxyl group or methyl ester,
C(1-3)alkoxy-C(1-5)alkoxy-C(1-5)alkyl wherein the C(1-3)alkoxy is optionally substituted with one hydroxyl group or methyl ester,
C(2-5)alkyl wherein the C(2-5)alkyl is substituted with one or two methyl esters and/or one or two hydroxyl groups,
C(2-12)alkyl, in particular C(2-5)alkyl,
C(2-12)alkenyl, in particular C(3-7)alkenyl,
C(2-12)alkynyl, in particular C(3-7)alkynyl, or
C(6)aryl-C(1-2)alkyl optionally substituted with one or more hydroxy, methoxy, amino, or C(1-3)alkyl groups,
   and/or one or more compounds according to formula Ia, R^{a}C(═O)OR^{b},
wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy.

Non-limiting examples of compounds according to formula I, wherein R¹ is C(1-5)alkoxy-C(1-5)alkyl wherein the C(1-5)alkoxy is optionally substituted with one hydroxyl group or methyl ester, are propylene glycol methyl ether acetate, 2-(2-hydroxyethoxy)ethyl acetate, and 2-(pentyloxy)ethyl acetate.

Non-limiting examples of compounds according to formula I, wherein R¹ is C(1-3)alkoxy-C(1-5)alkoxy-C(1-5)alkyl wherein the C(1-3)alkoxy is optionally substituted with one hydroxyl group or methyl ester, are dipropylene glycol methyl ether acetate, triethylene glycol diacetate, and tripropylene glycol diacetate.

Non-limiting examples of compounds according to formula I, wherein C(2-5)alkyl wherein the C(2-5)alkyl is substituted with one or two methyl esters and/or one or two hydroxyl groups, are ethylene glycol diacetate, propylene glycol diacetate, 1,3-butanediol diacetate, triacetin, diacetin, and monoacetin.

Non-limiting examples of compounds according to formula I, wherein R¹ is C(2-5)alkyl, are ethyl acetate, propyl acetate, butyl acetate, pentyl acetate, and isoamyl acetate. Other examples of compounds according to formula I, wherein R¹ is C(2-12)alkyl, are hexyl acetate, heptyl acetate, octyl acetate, nonyl acetate, decyl acetate, undecyl acetate, and dodecyl acetate.

Non-limiting examples of compounds according to formula I, wherein R¹ is C(2-12)alkenyl, in particular C(5-12)alkenyl, include cis-3-hexenyl methyl acetate.

Non-limiting examples of compounds according to formula I, wherein R¹ is C(2-12)alkynyl, in particular C(5-12)alkynyl, include methyl 2-octynoate.

Non-limiting examples of compounds according to formula I, wherein R¹ is C(6)aryl-C(1-2)alkyl optionally substituted with one or more hydroxy, methoxy, amino, or C(1-3)alkyl groups, are benzyl acetate, 4-hydroxybenzyl acetate, 4-methoxybenzyl acetate, 4-aminobenzyl acetate, (di)methylbenzyl acetate, 4-isopropylbenzyl acetate, and dimethylbenzylcarbinyl acetate.

Non-limiting examples of compounds according to formula Ia, wherein R^{a} is C(6)aryl optionally substituted with hydroxyl, and R^{b} is a C(1-6)alkyl or C(6)aryl-(C1-2)alkyl, are benzyl benzoate, hexyl salicylate and benzyl salicylate.

Non-limiting examples of compounds according to formula Ia, wherein R^{a} is C(6)aryl-C(1-2)alkyl and R^{b} is C(6)aryl optionally substituted with methyl or C(1-6)alkyl optionally substituted with C(6)aryl, are phenethyl phenylacetate, benzyl phenylacetate, ethyl phenylacetate, isoamyl phenylacetate, isobutyl phenylacetate, methyl phenylacetate, and p-tolyl phenylacetate.

Non-limiting examples of compounds according to formula Ia, wherein R^{a} is C(4-5)heteroaryl-C(1-2)alkyl and R^{b} is C(1-2)alkyl, are methyl 2-pyridylacetate, methyl 3-pyridylacetate, methyl 4-pyridylacetate, ethyl 2-pyridylacetate, ethyl 3-pyridylacetate, and ethyl 4-pyridylacetate.

Non-limiting examples of compounds according to formula Ia, wherein R^{a} is C(2-3)alkyl and R^{b} is C(6)aryl-C(1-2)alkyl optionally substituted with one or more hydroxy or methoxy, are benzyl butyrate, benzyl isobutyrate, and styrallyl propionate.

It may be preferred that, in the compound according to formula I, R¹ is C(1-5)alkoxy-C(1-5)alkyl wherein the C(1-5)alkoxy is optionally substituted with one hydroxyl group or methyl ester, C(1-3)alkoxy-C(1-5)alkoxy-C(1-5)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, C(3-5)alkyl substituted with one or two methyl esters, C(3-7)alkenyl, C(3-7)alkynyl, or C(6)aryl-C(1-2)alkyl optionally substituted with one or more hydroxy, methoxy, amino, or C(1-3)alkyl groups.

It may be preferred that, in the compound according to formula I, R¹ is C(1-5)alkoxy-C(1-5)alkyl wherein the C(1-5)alkoxy is optionally substituted with one hydroxyl group or methyl ester, C(1-3)alkoxy-C(1-5)alkoxy-C(1-5)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, C(3-5)alkyl substituted with one or two methyl esters, or C(3-7)alkynyl.

It may be preferred that, in the compound according to formula I, R¹ is C(1-5)alkoxy-C(1-5)alkyl wherein the C(1-5)alkoxy is optionally substituted with one hydroxyl group or methyl ester, C(1-3)alkoxy-C(1-5)alkoxy-C(1-5)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, or C(3-5)alkyl substituted with one or two methyl esters.

It may be preferred that, in the compound according to formula I, R¹ is C(1-5)alkoxy-C(2-3)alkyl wherein the C(1-5)alkoxy is optionally substituted with one hydroxyl group or methyl ester, C(1-3)alkoxy-C(2-3)alkoxy-C(2-3)alkyl wherein the C(1-3)alkoxy is optionally substituted with one hydroxyl group or methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, or C(3-5)alkyl substituted with one or two methyl esters.

It may be more preferred that, in the compound according to formula I, R¹ is C(1)alkoxy-C(1-5)alkyl, C(1)alkoxy-C(1-5)alkoxy-C(1-5)alkyl, C(2-3)alkoxy-C(1-5)alkoxy-C(1-5)alkyl wherein the C(2-3)alkoxy is substituted with one methyl ester, C(2)alkyl substituted with one hydroxyl group or one methyl ester, C(3-5)alkyl substituted with one hydroxyl group and one methyl ester, C(3-5)alkyl substituted with one or two hydroxyl groups, or C(3-5)alkyl substituted with one or two methyl esters.

It may be more preferred that, in the compound according to formula I, R¹ is C(2-3)alkoxy-C(1-5)alkoxy-C(1-5)alkyl wherein the C(2-3)alkoxy is optionally substituted with one methyl ester, C(2)alkyl substituted with one hydroxyl group or one methyl ester, C(3-5)alkyl substituted with one hydroxyl group and one methyl ester, C(3-5)alkyl substituted with two hydroxyl groups, or C(3-5)alkyl substituted with two methyl esters.

It may be more preferred that, in the compound according to formula I, R¹ is C(1)alkoxy-C(2-3)alkyl, C(1)alkoxy-C(2-3)alkoxy-C(2-3)alkyl, C(2)alkyl substituted with one hydroxyl group or one methyl ester, C(3-5)alkyl substituted with one hydroxyl group and one methyl ester, C(3-5)alkyl substituted with two hydroxyl groups, or C(3-5)alkyl substituted with two methyl esters.

It may be more preferred that, in the compound according to formula I, R¹ is C(2)alkyl substituted with one hydroxyl group or one methyl ester, C(3-5)alkyl substituted with one hydroxyl group and one methyl ester, C(3-5)alkyl substituted with two hydroxyl groups, or C(3-5)alkyl substituted with two methyl esters.

It may be more preferred that, in the compound according to formula I, R¹ is C(1)alkoxy-C(3)alkyl, C(1)alkoxy-C(3)alkoxy-C(3)alkyl, C(2)alkyl substituted with one hydroxyl group or one methyl ester, C(3)alkyl substituted with one hydroxyl group and one methyl ester, C(3)alkyl substituted with two hydroxyl groups, or C(3)alkyl substituted with two methyl esters.

In some embodiments, the compound of formula I is selected from the group consisting of propylene glycol methyl ether acetate, 2-(2-hydroxyethoxy)ethyl acetate, 2-(pentyloxy)ethyl acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, ethyl acetate, propyl acetate, butyl acetate, pentyl acetate, isoamyl acetate, hexyl acetate, heptyl acetate, octyl acetate, nonyl acetate, decyl acetate, undecyl acetate, dodecyl acetate, cis-3-hexenyl methyl acetate, methyl 2-octynoate benzyl acetate, 4-hydroxybenzyl acetate, 4-methoxybenzyl acetate, 4-aminobenzyl acetate, (di)methylbenzyl acetate, 4-isopropylbenzyl acetate, and dimethylbenzylcarbinyl acetate.

In some embodiments, the compound of formula I is selected from the group consisting of propylene glycol methyl ether acetate, 2-(2-hydroxyethoxy)ethyl acetate, 2-(pentyloxy)ethyl acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, propyl acetate, butyl acetate, pentyl acetate, isoamyl acetate, hexyl acetate, heptyl acetate, octyl acetate, methyl 2-octynoate benzyl acetate, (di)methylbenzyl acetate, 4-isopropylbenzyl acetate, and dimethylbenzylcarbinyl acetate.

It may be more preferred that the compound of formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamylacetate, propyl acetate, butyl acetate, pentyl acetate, 2-(2-hydroxyethoxy)ethyl acetate, and 2-(pentyloxy)ethyl acetate. The disinfecting composition may comprise at least one compound selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamyl acetate, propyl acetate, butyl acetate, pentyl acetate, 2-(2-hydroxyethoxy)ethyl acetate, and 2-(pentyloxy)ethyl acetate and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamylacetate, propyl acetate, butyl acetate, pentyl acetate, 2-(2-hydroxyethoxy)ethyl acetate, and 2-(pentyloxy)ethyl acetate.

It may be more preferred that the compound of formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, 2-(2-hydroxyethoxy)ethyl acetate, and 2-(pentyloxy)ethyl acetate. The disinfecting composition may comprise at least one compound selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, 2-(2-hydroxyethoxy)ethyl acetate, and 2-(pentyloxy)ethyl acetate and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, 2-(2-hydroxyethoxy)ethyl acetate, and 2-(pentyloxy)ethyl acetate.

It may be more preferred that the compound of formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin. The disinfecting composition may comprise at least one compound selected from the group consisting of propylene glycol methyl ether acetate, dipropylene glycol methyl ether acetate, triethylene glycol diacetate, tripropylene glycol diacetate, ethylene glycol diacetate, and propylene glycol diacetate, 1,3-butanediol diacetate, triacetin, and diacetin and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin.

It may be more preferred that the compound of formula I is selected from the group consisting of triethylene glycol diacetate, tripropylene glycol diacetate, ethylene glycol diacetate, propylene glycol diacetate, 1,3-butanediol diacetate, triacetin, and diacetin. The disinfecting composition may comprise at least one compound selected from the group consisting of triethylene glycol diacetate, tripropylene glycol diacetate, ethylene glycol diacetate, propylene glycol diacetate, 1,3-butanediol diacetate, triacetin, and diacetin and one or more further compounds according to formula I. For example, the disinfecting composition may comprise two or more compounds selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin.

It may be more preferred that the compound of formula I is selected from the group consisting of propylene glycol methyl ether acetate, dipropylene glycol methyl ether acetate, propylene glycol diacetate, and triacetin. The disinfecting composition may comprise at least one compound selected from the group consisting of propylene glycol methyl ether acetate, dipropylene glycol methyl ether acetate, propylene glycol diacetate, and triacetin and one or more further compounds according to formula I. The disinfecting composition preferably comprises triacetin and one or more further compounds according to formula I. For example, the disinfecting composition may comprise two or more compounds selected from the group consisting of propylene glycol methyl ether acetate, dipropylene glycol methyl ether acetate, propylene glycol diacetate, and triacetin. In a particular embodiment, the compound according to formula I is triacetin.

In some embodiments, the disinfecting composition comprises one or more compounds according to formula Ia, R^{a}C(═O)OR^{b}, wherein
R^{a} is C(6)aryl optionally substituted with hydroxyl, and R^{b} is C(1-6)alkyl or C(6)aryl-(C1-2)alkyl,
R^{a} is C(6)aryl-C(1-2)alkyl and R^{b} is C(6)aryl optionally substituted with methyl or C(1-6)alkyl optionally substituted with C(6)aryl, or
R^{a} is C(2-3)alkyl and R^{b} is C(6)aryl-C(1-2)alkyl optionally substituted with one or more hydroxy or methoxy.

In some embodiments, the disinfecting composition comprises one or more compounds according to formula Ia, R^{a}C(═O)OR^{b}, wherein
R^{a} is C(6)aryl optionally substituted with hydroxyl, and R^{b} is C(1-6)alkyl or C(6)aryl-(C1-2)alkyl, or
R^{a} is C(6)aryl-C(1-2)alkyl and R^{b} is C(6)aryl optionally substituted with methyl or C(1-6)alkyl optionally substituted with C(6)aryl.

In some embodiments, the disinfecting composition comprises one or more compounds according to formula Ia, R^{a}C(═O)OR^{b}, wherein
R^{a} is C(6)aryl and R^{b} is C(6)aryl-(C1-2)alkyl, or
R^{a} is C(6)aryl substituted with hydroxyl and R^{b} is a C(1-6)alkyl.

In some embodiments, the one or more compounds according to formula Ia are selected from the group consisting of benzyl benzoate, hexyl salicylate, benzyl salicylate, phenethyl phenylacetate, benzyl phenylacetate, ethyl phenylacetate, isoamyl phenylacetate, isobutyl phenylacetate, methyl phenylacetate, p-tolyl phenylacetate, methyl 2-pyridylacetate, methyl 3-pyridylacetate, methyl 4-pyridylacetate, ethyl 2-pyridylacetate, ethyl 3-pyridylacetate, ethyl 4-pyridylacetate, benzyl butyrate, benzyl isobutyrate, and styrallyl propionate.

In some embodiments, the one or more compounds according to formula Ia are selected from the group consisting of benzyl benzoate, hexyl salicylate, benzyl salicylate, phenethyl phenylacetate, benzyl phenylacetate, ethyl phenylacetate, isoamyl phenylacetate, isobutyl phenylacetate, ethyl 4-pyridylacetate benzyl butyrate, benzyl isobutyrate, and styrallyl propionate.

The disinfecting composition comprises the compound of formula I and/or the compound of formula Ia in a total amount of from 0.1 to 20 wt. % (calculated on the total weight of the disinfecting composition). The compound of formula I and/or the compound of formula Ia may be present in a total amount of from 0.2 to 20 wt. % (calculated on the total weight of the disinfecting composition), in particular 0.3 to 20 wt. %, more in particular 0.4 to 20 wt. %, even more in particular 0.5 to 20 wt. %, even more in particular 0.8 to 15 wt. %, even more in particular 1.0 to 10 wt. %, even more in particular 1.5 wt. % to 8.0 wt. %.

The disinfecting composition may comprise the compound of formula I in a total amount of from 0.1 to 20 wt. % (calculated on the total weight of the disinfecting composition). The compound of formula I may be present in a total amount of from 0.2 to 20 wt. % (calculated on the total weight of the disinfecting composition), in particular 0.3 to 20 wt. %, more in particular 0.4 to 20 wt. %, even more in particular 0.5 to 20 wt. %, even more in particular 0.8 to 15 wt. %, even more in particular 1.0 to 10 wt. %, even more in particular 1.5 wt. % to 8.0 wt. %.

The disinfecting composition may comprise the compound of formula Ia in a total amount of from 0.1 to 20 wt. % (calculated on the total weight of the disinfecting composition). The compound of formula I may be present in a total amount of from 0.2 to 20 wt. % (calculated on the total weight of the disinfecting composition), in particular 0.3 to 20 wt. %, more in particular 0.4 to 20 wt. %, even more in particular 0.5 to 20 wt. %, even more in particular 0.8 to 15 wt. %, even more in particular 1.0 to 10 wt. %, even more in particular 1.5 wt. % to 8.0 wt. %.

### Hydrogen Peroxide

The disinfecting composition comprises hydrogen peroxide in an amount of 0.1 to 15 wt. % (calculated as the net weight of hydrogen peroxide on the total weight of the composition). Hydrogen peroxide is particularly attractive as a biocidally active compound because its decomposition products, water and oxygen, are not toxic and not harmful to the environment.

The disinfecting composition may comprise the hydrogen peroxide in an amount of from 0.2 to 7.0 wt. % (calculated as the net weight of hydrogen peroxide on the total weight of the composition), in particular from 0.3 to 6.0 wt. %, more in particular from 0.4 to 5.0 wt. %, more in particular 0.5 to 3.0 wt. %. These concentrations were found to be particularly useful in disinfecting compositions for application, because they aid in achieving surprisingly fast and effective antimicrobial action with good material compatibility.

In order to provide fast, effective action, biocidal hydrogen peroxide solutions previously had to employ relatively high concentrations of hydrogen peroxide. However, at such higher concentrations, the solutions may be subject to hazardous goods regulations and may require special precautions for handling and use. For example, at concentrations of above about 7.5 wt. % aqueous solution, hydrogen peroxide is considered corrosive and is also a strong oxidizing agent. Surprisingly, it has been found that the use of relatively limited amounts of hydrogen peroxide in the disinfecting compositions according to the disclosure can, in combination with the other compounds of the present composition, provide good antifungal, antiviral and antibacterial activity against difficult-to-kill fungi, viruses and bacteria.

The disinfecting composition may also comprise the hydrogen peroxide in an amount of from 7.5 to 15 wt. % (calculated as the net weight of hydrogen peroxide on the total weight of the composition), in particular from 5.0 to 12 wt. %. These concentrations are particularly useful in sporicidal disinfecting compositions, i.e., in sterilants.

The weight ratio of the total weight of the compounds according to formula I (a) to the net weight of the hydrogen peroxide is from 5:1 to 1:5. In some embodiments, the ratio of the total weight of the compounds according to formula I (a) to the net weight of the hydrogen peroxide is from 4:1 to 1:4, in particular from 3:1 to 1:3, more in particular from 1:1 to 1:2.5.

### N-Acylated Amino Acids or Salts Thereof

The disinfecting composition comprises one or more N-acylated amino acids or salts thereof in a total amount of from 0.01 to 10.0 wt. % (calculated on the total weight of the composition), in particular from 0.05 to 7.5 wt. % of the N-acylated amino acid or salt thereof, in particular from 0.10 to 5.0 wt. % of the N-acylated amino acid or salt thereof, in particular from 0.15 to 3.0 wt. % of the N-acylated amino acid or salt thereof, in particular from 0.18 to 1.5 wt. % of the N-acylated amino acid or salt thereof, more in particular from 0.3 to 1.5 wt. % of the N-acylated amino acid or salt thereof, even more in particular from 0.4 to 1.5 wt. % of the N-acylated amino acid or salt thereof.

The N-acylated amino acid may have a structure according to formula III:

R³—C(═O)—N(R⁴)—(CH₂)ₙ—CH(R⁵)—C(═O)OH or a salt thereof,

wherein R³—C(═O)— represents an acyl group wherein R³ is a C(5-21)alkyl radical or a C(5-21)alkylene radical, R⁴ is H or CH₃, R⁵ represents an amino acid side-chain, and n is 0, 1 or 2. In particular embodiments of the structure according to formula III, R³ is C(5-21)alkyl, in particular C(5-21)alkyl, more in particular C(5-14)alkyl, more in particular a straight-chain C(5-14)alkyl. In particular embodiments of the structure according to formula III, R⁴ is CH₃. In particular embodiments of the structure according to formula III, R⁵ represents a side-chain of an amino acid selected from the group consisting of glutamic acid, glutamate, aspartic acid, glutamine, glycine, asparagine, lysine, arginine, histidine, proline, sarcosine, threonine or serine, in particular a side-chain of an amino acid selected from the group consisting of glutamic acid, glutamate, sarcosine, glycine, aspartic acid and lysine.

In particular embodiments, the N-acylated amino acid may have a structure according to formula III:

R³—C(═O)—N(R⁴)—(CH₂)ₙ—CH(R⁵)—C(═O)OH or a salt thereof,

wherein R³—C(═O)— represents an acyl group wherein R³ is a C(5-21)alkyl radical or a C(5-21)alkylene radical, R⁴ is H or CH₃, R⁵ represents an amino acid side-chain of an amino acid selected from the group consisting of glycine and glutamine, and n is 1. In particular embodiments of the structure according to formula III, R³ is C(5-21)alkyl, in particular C(5-21)alkyl, more in particular C(5-14)alkyl, more in particular a straight-chain C(5-14)alkyl. In particular embodiments of the structure according to formula III, R⁴ is CH₃.

In more particular embodiments, the N-acylated amino acid may have a structure according to formula III:

R³—C(═O)—N(R⁴)—(CH₂)ₙ—CH(R⁵)—C(═O)OH or a salt thereof,

wherein R³—C(═O)— represents an acyl group wherein R³ is a C(5-21)alkyl radical or a C(5-21)alkylene radical, R⁴ is H or CH₃, R⁵ represents an amino acid side-chain of glycine (i.e. H), and n is 1. In particular embodiments of the structure according to formula III, R³ is C(5-21)alkyl, in particular C(5-21)alkyl, more in particular C(5-14)alkyl, more in particular a straight-chain C(5-14)alkyl. In particular embodiments of the structure according to formula III, R⁴ is CH₃.

Preferably, the disinfecting composition comprises an N-acylated amino acid that is an N-acyl sarcosine according to formula Illa, R³—C(═O)—N(CH₃)—CH₂—C(═O)OH or a salt thereof, wherein R³ is a C(5-21)alkyl radical, in particular wherein R³ is a C(5-12)alkyl radical, more in particular wherein R³ is a straight-chain C(5-14)alkyl radical, in particular a straight-chain C(7-13)alkyl radical. The N-acylated amino acid or a salt thereof is, thus, preferably an N-acylated sarcosinate or a salt thereof. The disinfecting composition may comprise 0.01 to 10.0 wt. % of an N-acylated sarcosinate or salt thereof (calculated on the total weight of the composition), in particular from 0.05 to 7.5 wt. % of the N-acylated sarcosine or salt thereof, in particular from 0.10 to 5.0 wt. % of the N-acylated sarcosinate or salt thereof, in particular from 0.15 to 3.0 wt. % of the N-acylated sarcosinate or salt thereof, in particular from 0.20 to 1.5 wt. % of the N-acylated sarcosinate or salt thereof. Examples of N-acylated amino acids according to formula Illa are N-lauroyl sarcosine, N-myristoyl sarcosine, N-cocoyl sarcosine, N-oleoyl sarcosine, and N-stearoyl sarcosine. Examples of salts of N-acylated amino acids according to formula Illa are sodium lauroyl sarcosinate, sodium myristoyl sarcosinate, sodium cocoyl sarcosinate, sodium oleoyl sarcosinate, and sodium stearoyl sarcosinate.

The N-acylated amino acid may also have a structure according to formula IIIb:

R^{c}—C(═O)—N(R^{d})—(CH₂)₂—S(═O)₂OH or a salt thereof,

wherein R^{c}—C(═O)— represents an acyl group wherein R^{c} is a C(5-21)alkyl radical or a C(5-21)alkylene radical and R^{d} is H, CH₃, or cyclohexyl. In particular embodiments of the structure according to formula IIIb, R^{d} is C(5-21)alkyl, in particular C(5-21)alkyl, more in particular C(5-14)alkyl, more in particular a straight-chain C(5-14)alkyl. In particular embodiments of the structure according to formula IIIb, R^{d} is H or CH₃, more in particular R^{d} is CH₃. Examples of compounds according to formula IIIb are sodium N-cyclohexyl-N-palmitoyltaurate, sodium N-cis-1-oxo-9-octadecenyl-N-methyltaurine, sodium N-palmitoyl-N-methyltaurine, sodium N-lauroyl-N-methyltaurine, and sodium N-cis-9-octadecenyl-N-methyltaurine.

In a preferred embodiment, the N-acylated amino acid is one or more selected from the group consisting of N-lauroyl sarcosine, N-myristoyl sarcosine, N-cocoyl sarcosine, N-oleoyl sarcosine, N-stearoyl sarcosine, sodium lauroyl sarcosinate, sodium myristoyl sarcosinate, sodium cocoyl sarcosinate, sodium oleoyl sarcosinate, sodium stearoyl sarcosinate, N-lauroyl glycine, N-myristoyl glycine, N-cocoyl glycine, N-oleoyl glycine, N-stearoyl glycine, sodium lauroyl glycinate, sodium myristoyl glycinate, sodium cocoyl glycinate, sodium oleoyl glycinate, sodium stearoyl glycinate, N-lauroyl glutamine, N-myristoyl glutamine, N-cocoyl glutamine, N-oleoyl glutamine, N-stearoyl glutamine, sodium lauroyl glutamate, sodium myristoyl glutamate, sodium cocoyl glutamate, sodium oleoyl glutamate, sodium stearoyl glutamate, sodium N-cyclohexyl-N-palmitoyltaurate, sodium N-cis-1-oxo-9-octadecenyl-N-methyltaurine, sodium N-palmitoyl-N-methyltaurine, sodium N-lauroyl-N-methyltaurine, and sodium N-cis-9-octadecenyl-N-methyltaurine.

In a preferred embodiment, the N-acylated amino acid is one or more selected from the group consisting of N-lauroyl sarcosine, N-myristoyl sarcosine, N-cocoyl sarcosine, N-oleoyl sarcosine, N-stearoyl sarcosine, N-lauroyl glycine, N-myristoyl glycine, N-cocoyl glycine, N-oleoyl glycine, N-stearoyl glycine, N-lauroyl glutamine, N-myristoyl glutamine, N-cocoyl glutamine, N-oleoyl glutamine, and N-stearoyl glutamine.

In a preferred embodiment, the N-acylated amino acid is one or more selected from the group consisting of sodium lauroyl sarcosinate, sodium myristoyl sarcosinate, sodium cocoyl sarcosinate, sodium oleoyl sarcosinate, sodium stearoyl sarcosinate, sodium lauroyl glycinate, sodium myristoyl glycinate, sodium cocoyl glycinate, sodium oleoyl glycinate, sodium stearoyl glycinate, sodium lauroyl glutamate, sodium myristoyl glutamate, sodium cocoyl glutamate, sodium oleoyl glutamate, sodium stearoyl glutamate, sodium N-cyclohexyl-N-palmitoyltaurate, sodium N-cis-1-oxo-9-octadecenyl-N-methyltaurine, sodium N-palmitoyl-N-methyltaurine, sodium N-lauroyl-N-methyltaurine, and sodium N-cis-9-octadecenyl-N-methyltaurine.

### Anionic Surfactant

The disinfecting composition comprises one or more surfactants selected from the group consisting of non-ethoxylated anionic surfactants and salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition).

Accordingly, the disinfecting composition may comprise 0.2-20 wt. % of one or more non-ethoxylated anionic surfactants (calculated on the total weight of the composition). It may be preferred for the amount of non-ethoxylated anionic surfactant to be in the range of 0.3-15 wt. % (calculated on the total weight of the composition), in particular in the range of 0.5-10 wt. %, more in particular 0.5-8 wt. %. If the amount of non-ethoxylated anionic surfactant is too low, the effect of the present invention will not be obtained. On the other hand, if the amount is too high, the composition may become corrosive to skin or surfaces, which is an undesired effect.

The term “non-ethoxylated anionic surfactant” according to the invention refers to anionic surfactants that do not contain one or more ethoxy-groups. Anionic surfactants carry an anionic charge, or have anionic character in an acidic environment.

Examples of non-ethoxylated anionic surfactants include the following surfactant types, whereby this list is in no way exhaustive and is meant purely for illustrative purposes: acids or the salts of alkyl sulphates (e.g. triethanolamine lauryl sulphate and monoisopropanolamine lauryl sulphate), acids or salts of cycloalkyl sulphates, acids or salts of alkylaryl sulphates (e.g. acids such as sodium xylene sulphonic acid, sodium dodecylbenzene sulphonic acid, and salts such as sodium xylene sulphate, sodium dodecylbenzene sulphate), acids or salts of arylalkyl sulphates, acids or salts of alkyl phosphates, acids or salts of alkyl carboxylates (e.g. sodium lauryl glucose carboxylate and sodium lauryl glycol carboxylate), salts of alkyl lactylates (e.g. sodium lauroyl lactylate), salts of alkyl sulphoacetates (e.g. sodium lauryl sulphoacetate), salts of alkyl sulphosuccinates (sodium lauryl sulphosuccinate), salts of sulpholaurates (e.g. sodium methyl 2-sulpholaurate and disodium 2-sulpholaurate), salts of anionic alkyl polyglucosides (e.g. disodium cocopolyglucose citrate, disodium cocopolyglucose sulphosuccinate, and sodium cocopolyglucose tartrate), salts of alkyl taurates (e.g. sodium lauryl taurate and sodium cocoyl taurate) and salts of alkyl isethionates (sodium lauroyl isethionate and sodium cocoyl isethionate). The (cyclo)alkyl groups of these non-ethoxylated anionic surfactants may have 4-22 carbon atoms, in particular 8-18 carbon atoms, more in particular 10-18 carbon atoms.

The use of alkyl sulphates or alkyl sulphonic acids as anionic surfactant may be preferred. In some embodiments, the non-ethoxylated anionic surfactant comprises a C(4-22)alkyl sulphate salt, in particular a C(8-18)alkyl sulphate salt, more in particular a C(10-18)alkyl sulphate salt. In some embodiments, the non-ethoxylated anionic surfactant is selected from the group consisting of lauryl sulphate, cocoyl sulphate, or myristyl sulphate.

In some embodiments, the disinfecting composition comprises at most 5.0 wt. % of the non-ethoxylated surfactant (calculated on the total weight of the composition), in particular at most 4.0 wt. %, more in particular at most 3.0 wt. %, more in particular at most 2.0 wt. %, more in particular at most 1.0 wt. %, more in particular at most 0.5 wt. %, more in particular less than 0.1 wt. %.

The disinfecting composition may comprise 0.2-20 wt. % (calculated on the total weight of the composition) of one or more salts of a compound according to formula II, R²—(O—CH₂—CH₂)ₘ—O—SO₃, wherein R² is C(8-18)alkyl and m is 1-6. It may be preferred for the amount of the compound according to formula II to be in the range of 0.2-15 wt. % (calculated on the total weight of the composition), in particular in the range of 0.5-10 wt. %, more in particular 0.5-8 wt. %. In the compound according to formula II, R²—(O—CH₂—CH₂)ₘ—O—SO₃, R² is preferably C(10-14)alkyl and m is preferably 1-4. For example, the compound according to formula II may be a salt or lauryl ether sulphate.

Suitable counterions of the salts of the (non-) ethoxylated anionic surfactants are selected from sodium, potassium, ammonium, calcium, magnesium, zinc, and organic amine groups (such as mono-, di-, or tri-alkylamines, where the amine group has 1˜4 carbon atoms). Preferably, in the instance that the salt is an amine salt, the alkyl sulphate salt is a monoisopropanolamine salt, a triethanolamine salt, or an ammonium salt.

In some embodiments, the disinfecting composition comprises at most 5.0 wt. % of the one or more compounds according to formula II (calculated on the total weight of the composition), in particular at most 4.0 wt. %, more in particular at most 3.0 wt. %, more in particular at most 2.0 wt. %, more in particular at most 1.0 wt. %, more in particular at most 0.5 wt. %, more in particular less than 0.1 wt. %.

In some embodiments, the non-ethoxylated surfactant and the compound according to formula II are both present. Thus, in some embodiments, the non-ethoxylated surfactant and the one or more compounds according to formula II are present in the disinfection composition in a total amount of from 0.2 to 20 wt. % (calculated on the total weight of the composition), in particular in an amount of from 0.2 to 15.0 wt. %, more in particular in an amount of from 0.3 to 10.0 wt. %, more in particular in an amount of from 0.5 to 7.5 wt. %, more in particular in an amount of from 0.8 to 5.0 wt. %, more in particular in an amount of from 1.0 to 3.0 wt. %.

pH of the disinfecting composition

The disinfecting composition has a pH of from 0.5 to 4.0. The disinfecting composition may have a pH of from 1.0 to 3.5, in particular 1.5 to 3.0, more in particular 1.5 to 2.5. It has been found that the disinfecting composition achieves optimal antimicrobial activity within the above-mentioned range. At higher pH values, the antimicrobial activity drops, leaving a composition with little to no antimicrobial activity.

A pH-adjusting acid or base, or an appropriate buffer, may be used to provide the disinfecting composition with the pH defined above. Suitable acids are organic and inorganic acids. The disinfection composition may, for example, further comprise a carboxylic acid. Suitable carboxylic acids are carboxylic acids selected from the group consisting of lactic acid, tartaric acid, acetic acid, succinic acid, benzoic acid, salicylic acid, malic acid, maleic acid, citric acid, glycolic acid, furoic acid, and fumaric acid. Particularly, the carboxylic acids may be benzoic acid, salicylic acid, or a mixture thereof. In particular embodiments, the disinfecting compositions composition comprises benzoic acid and salicylic acid. Suitable inorganic acids are phosphoric acid, sulfamic acid, nitric acid, methane sulphonic acid, and sulphuric acid, of which phosphoric acid, sulfamic acid or methane sulphonic acid may be preferred. The organic acids and inorganic acids mentioned above may be present in the disinfecting composition in a total amount of from 0.05 to 2.0 wt. % (calculated on the total weight of the composition), in particular 0.1 to 1.5 wt. %, more in particular 0.2 to 1.0 wt. %, more in particular 0.3 to 0.8 wt. %, even more in particular 0.5 to 0.8 wt. %. Combinations of (organic and inorganic) acids may be used.

Suitable bases are organic and inorganic bases. For example, the disinfecting composition may further comprise a hydroxide salt (e.g., NaOH, KOH) or a (bi) carbonate salt (e.g. Na₂CO₃, K₂CO₃). The organic bases and inorganic bases mentioned above may be present in the disinfecting composition in a total amount of from 0.1 to 2.0 wt. % (calculated on the total weight of the composition), in particular 0.2 to 1.0 wt. %. Combinations of (organic and inorganic) bases may be used.

### Other Components

The disinfecting composition may optionally further comprise a peroxy acid or a precursor thereof. Suitable peroxy acids can be organic or inorganic peroxy acids. For example, the disinfecting composition may further comprise a percarboxylic acid or a precursor thereof, more in particular a percarboxylic acid or precursor thereof selected from the group consisting of peracetic acid, perpropionic acid, percitric acid, perlactic acid, performic acid, pertartaric acid, persuccinic acid, perbenzoic acid, persalisylic acid, permalic acid, permaleic acid, perglycolic acid, perfuroic acid, perfumaric acid, and precursors thereof, more in particular a percarboxylic acid or precursor thereof selected from the group consisting of peracetic acid, perpropionic acid, percitric acid, perlactic acid, and precursors thereof, more in particular peracetic acid or a precursor thereof. An example of a suitable inorganic peroxy acid is peroxymonosulphuric acid.

The disinfecting composition may optionally further comprise a (hydrogen) peroxide stabilizer. Such stabilizer may preferably be a sequestering agent or chelating agent. In general, a chelating agent is a molecule capable of coordinating (i.e., binding) the metal ions commonly found in water sources to prevent the metal ions from interfering with the action of the other ingredients. Preferred are chelating agents with a high binding affinity at low pH, and good water solubility at low pH. Examples of chelating agents include phosphonic acid and phosphonates, phosphates, aminocarboxylates and their derivatives, pyrophosphates, ethylenediamine and ethylenetriamine derivatives, hydroxyacids, and mono-, di-, and tri-carboxylates and their corresponding acids. Other chelating agents include nitroloacetates and their derivatives, and mixtures thereof, ethylenediaminetetraacetic acid (EDTA), diethylenetriaminepentaacetic acid (DTPA), N-(hydroxyethyl)-ethylenediaminetriacetic acid (HEDTA), nitrilotriacetic acid (NTA), 2-hydroxyethyliminodiacetic acid (HEIDA), and salts thereof or from benzoic acid, salicylic acid, aminobenzoic acid, citric acid, phosphoric acid, iminodisuccinic acid and polyaspartic acid. More preferably, the chelating agent is a (colloidal) stannate, and even more preferably is chosen from acetanilide, trisodium ethylenediamine disuccinate (EDDS), for instance OctaQuest E30 or A65 (Octel), derivatives of glutamic acid, such as glutamic acid diacetic acid (tetra) sodium salt (GLDA), iminodisuccinic acid and salts (IDS), organophosphonic acid derivatives, and its salts, having 1 to 5 phosphonic acid groups, for instance a Dequest phosphonate (Solutia), such as for example 1-hydroxyethylidene-1,1-diphosphonic acid, amino tri(methylene phosphonic acid), diethylenetriamine-penta(methylene phosphonic acid), 2-hydroxy ethylimino bis(methylene phosphonic acid), ethylene diamine tetra(methylene phosphonic acid), and pyridine carboxylic acid-based stabilizers (such as picolinic acids and salts thereof) can be used. The use of phosphonic acid and its derivatives is considered preferred. However, the list of chelating agents does not imply to limit the selection to these substances. It is clear to the skilled person that any substance with chelating or metal-ion binding capacities may be selected. The disinfecting composition may comprise 0.01-2.0 wt. % of a sequestering agent (calculated on the total weight of the composition). The chelating agent is preferably present in an amount of 0.01-2.0 wt. % (calculated on the total weight of the composition), in particular 0.05-1.5 wt. %, more in particular 0.1-1.0 wt. %. Mixtures of different sequestering agents and/or chelating agents may also be used.

In view of their high binding activity at low pH and good water solubility at low pH, organophosphonates, cyclic carboxylic acids, and aminopolycarboxylic acids (such as GLDA, IDS and EDDS) may be particularly preferred.

The disinfecting composition is generally water-based, i.e., aqueous. Thus, the composition may comprise water. For example, the disinfecting composition may comprise from 55 to 99.3 wt. % of water (based on the total weight of the composition), in particular 75 to 98 wt. % of water, more in particular 80 to 97 wt. % of water, even more in particular 85 to 95 wt. % of water. For example, the disinfecting composition may, in particular, comprise one or more compounds according to formula I in a total amount of from 0.5 to 10.0 wt. %; from 0.1 to 6.0 wt. % of hydrogen peroxide; from 0.01 to 10 wt. % of one or more N-acylated amino acids, or a salt thereof; from 0.1 to 20 wt. % of one or more surfactants selected from the group consisting of non-ethoxylated anionic surfactants and salts of a compound according to formula III; and 75 to 99.3 wt. % water (calculated on the total weigh of the composition).

The disinfecting composition may optionally comprise a further solvent selected from the group consisting of propylene glycol methyl ether, dipropylene glycol methyl ether, tripropylene glycol methyl ether, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, dipropylene glycol phenyl ether, dipropylene glycol dimethyl ether, diethylene glycol methyl ether, triethylene glycol methyl ether, diethylene glycol ethyl ether, triethylene glycol ethyl ether, ethylene glycol propyl ether, ethylene glycol n-butyl ether, diethylene glycol n-butyl ether, triethylene glycol n-butyl ether, ethylene glycol hexyl ether, diethylene glycol hexyl ether, ethylene glycol phenyl ether, and diethylene glycol phenyl ether. The further solvent may, in particular, be propylene glycol n-butyl ether, dipropylene glycol n-butyl ether, or a mixture thereof. The further solvent may, more in particular, be propylene glycol n-butyl ether. The further solvent may be present in an amount of from 0.1 to 10 wt. % (calculated on the total weight of the composition), even more in particular 0.5 to 8.0 wt. %, still more in particular 1.0 to 5.0 wt. %. In some embodiments, the disinfecting composition comprises less than 3.0 wt. % of a further solvent defined above (calculated on the total weight of the composition), in particular less than 2.0 wt. %, more in particular less than 1.0 wt. %, more in particular less than 0.5 wt. %, more in particular less than 0.1 wt. %. In some embodiments, the disinfecting composition comprises less than 3.0 wt. % of propylene glycol n-butyl ether and/or dipropylene glycol n-butyl ether (calculated on the total weight of the composition), in particular less than 2.0 wt. %, more in particular less than 1.0 wt. %, more in particular less than 0.5 wt. %, more in particular less than 0.1 wt. %.

The disinfecting composition may further comprise a non-ionic surfactant. For example, the disinfecting composition may comprise an alkyl polyglucoside. Suitable alkyl polyglucosides are alkyl polyglucosides according to formula IV:

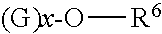

wherein G is a reducing saccharide moiety comprising 5 or 6 carbon atoms (in particular, 6 carbon atoms), R⁶ is a straight-chain or branched alkyl or alkylene group having 6-14 carbon atoms, and x represents the number of monosaccharide repeating units in the polyglucoside, wherein x is 1-8 (in particular, x is 1-5; more in particular, x is 1-3). The alkyl polyglucoside may preferably comprise the saccharide or polysaccharide groups (i.e., mono-, di-, tri-, etc. saccharides) of hexose or pentose, and a fatty aliphatic group with 6 to 20 carbon atoms. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in the making of polyglycosides. Examples of commercial suppliers of alkyl polyglucosides are Dow, BASF, Seppic, Akzo Nobel, and Croda. Functionalized alkyl polyglucosides may also be included, with cationic, amphoteric, or anionic functional groups.

The disinfecting composition according to the disclosure may comprise the alkyl polyglucoside in an amount of from 0.01 to 5.0 wt. % (calculated on the total weight of the composition), in particular in an amount of from 0.05 to 1.0 wt. %.

The disinfecting composition may comprise less than 3.0 wt. % of benzyl alcohol (calculated on the total weight of the composition), in particular less than 2.0 wt. % of benzyl alcohol, in particular less than 1.0 wt. % of benzyl alcohol, in particular less than 0.5 wt. % of benzyl alcohol, in particular less than 0.3 wt. % of benzyl alcohol, more in particular less than 0.1 wt. % of benzyl alcohol. As shown in the Examples, the use of benzyl alcohol as a solvent may be detrimental to material compatibility when used in amounts of equal to or greater than 3.0 wt. %.

The disinfecting composition is suitable for disinfecting a surface (suspected of being) infected with bacteria (in particular, Staphylococcus aureus), and/or fungi (in particular Candida auris) and/or a non-enveloped virus (in particular, Norovirus and/or Feline Calicivirus). In some embodiments, the disinfecting composition passes the ASTM E1053-20 standard for viruses against Feline Calicivirus (the official USA EPA surrogate virus for Human Norovirus), as amended for impregnated towelettes in 60 seconds or less, in particular in 50 seconds or less (i.e., displays a log reduction of at least 3.0 against Feline Calicivirus). In some embodiments, the disinfecting composition passes the Germicidal Towelette Method/AOAC Official Method 961.02 for impregnated towelettes in 60 seconds or less, in particular in 50 seconds or less (i.e., having sufficient germkill against S. aureus in a Germicidal Towelette Method/AOAC Official Method 961.02 test where a total of sixty (60) carriers). In some embodiments the product passes the OECD Quantitative Method for Evaluating the Efficacy of Antimicrobial Products against Candida auris on Hard, Non-Porous Surfaces (i.e., displays a log reduction of at least 5.0 against Candida auris).

The disinfecting composition may comprise less than 10 wt. % silica (calculated on the total weight of the composition), in particular less than 2.5 wt. %.

The disinfecting composition may comprise less than 0.5 wt. % of a perhydrolase (calculated on the total weight of the composition), in particular less than 0.1 wt. % of a perhydrolase, more in particular is substantially free from perhydrolases, even more in particular be free from perhydrolases.

The disinfecting composition may comprise less than 4.0 wt. % of a C3-C6 N-alkyl-gamma-butyrolactam (calculated on the total weight of the composition), in particular less than 3.0 wt. %, more in particular less than 2.0 wt. %, more in particular less than 1.0 wt. %, more in particular less than 0.1 wt. %, more in particular less than 0.04 wt. %, more in particular be substantially free from C3-C6 N-alkyl-gamma-butyrolactam. As used herein, a “C3-C6 N-alkyl-gamma-butyrolactam” is a gamma-butyrolactam group—that is, a five-membered lactam group-substituted at nitrogen, wherein the nitrogen atom may be substituted with a branched or unbranched, saturated or unsaturated, substituted or unsubstituted C(3-6)alkyl chain. An example of a C3-C6 N-alkyl-gamma-butyrolactam is TamiSolve® NxG (Eastman Chemical Company).

The disinfecting composition may comprise less than 15 wt. % of C(1-6)alkylalcohol (calculated on the total weight of the composition), in particular ethanol. It is preferred for the disinfecting composition to comprise less than 10 wt. % of C(1-6)alkylalcohol (in particular, of ethanol), in particular less than 5.0 wt. % of C(1-6)alkylalcohol (in particular, of ethanol). The composition may comprise less than 2.0 wt. % C(1-6)alkylalcohol (e.g. ethanol), or be substantially free of C(1-6)alkylalcohol (e.g. ethanol), or free of C(1-6)alkylalcohol (e.g. ethanol). A disadvantage of C(1-6)alkylalcohols is that they are flammable at room-temperature at levels exceeding 20-25 wt. %. Additionally, at least some of them have potential for causing eye irritation. More specifically, n-propanol is classified as causing serious eye damage with in class H318 in the Globally Harmonized Hazard Classification System (GHS), while isopropyl alcohol and ethanol are both classified as causing serious eye irritation in class H319. Due to their high volatility, C(1-6)alkylalcohols may cause fumes which are detrimental to the user's respiratory tract. In addition to the above safety aspects, C(1-6)alkylalcohols have an adverse effect on many surfaces (such as linoleum, plastic composites, PVC, PMMA, rubbers, glues, painted surfaces, etc.), making their use as hard-surface cleaner not attractive.

It will be clear to the skilled person that combinations of the above-mentioned embodiments are envisaged. For example, the disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % of (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % of (calculated on the total weight of the composition);
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition);
f) from 0.01 to 2.0 wt. % of a hydrogen peroxide stabilizer (calculated on the total weight of the composition);
g) one or more acids in a total amount of from 0.1 to 2.0 wt. % of (calculated on the total weight of the composition);
wherein the disinfecting composition has a pH of from 1.5 to 3.0, and optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters,
in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids, or a salt thereof, in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition),
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition);
wherein the disinfecting composition has a pH of from 1.5 to 3.0, and optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % of (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % of (calculated on the total weight of the composition);
wherein the disinfecting composition has a pH of from 1.5 to 3.0, and optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition), optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition);
f) from 0.01 to 2.0 wt. % of a hydrogen peroxide stabilizer (calculated on the total weight of the composition);
g) one or more acids in a total amount of from 0.1 to 2.0 wt. % of (calculated on the total weight of the composition);
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters, and/or
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
   b) from 7.5 to 15 wt. % of hydrogen peroxide (calculated as the net weight of hydrogen peroxide on the total weight of the composition);
   c) one or more N-acylated amino acids, or a salt thereof, in a total amount of from 0.01 to 10 wt. % (calculated on the total weight of the composition);
   d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition),
   e) from 0.01 to 2.0 wt. % of a hydrogen peroxide stabilizer (calculated on the total weight of the composition);
   f) one or more acids in a total amount of from 0.1 to 2.0 wt. % (calculated on the total weight of the composition);
   wherein the disinfecting composition has a pH of from 1.5 to 3.0, and
   optionally wherein the disinfecting composition comprises a percarboxylic acid or a precursor thereof,
   optionally wherein the disinfecting composition comprises less than 0.1 wt. % of a C3-C6 N-alkyl-gamma-butyrolactam (calculated on the total weight of the composition),
   optionally wherein the disinfecting composition comprises less than 0.1 wt. % of a perhydrolase (calculated on the total weight of the composition),
   optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester, C(3-5)alkyl substituted with one hydroxyl group and one methyl ester,
   C(3-5)alkyl substituted with one or two hydroxyl groups, or
   C(3-5)alkyl substituted with one or two methyl esters, and
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % of (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % of (calculated on the total weight of the composition);
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or C(3-5)alkyl substituted with one or two methyl esters, and
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters, and
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition);
f) from 0.01 to 2.0 wt. % of a hydrogen peroxide stabilizer (calculated on the total weight of the composition);
g) one or more acids in a total amount of from 0.1 to 2.0 wt. % of (calculated on the total weight of the composition);
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula I, CH₃C(═O)OR¹, wherein R¹ is
   C(1-5)alkoxy-C(2-3)alkyl wherein the C(1-5)alkoxy is optionally substituted with one hydroxyl group or methyl ester,
   C(1-3)alkoxy-C(2-3)alkoxy-C(2-3)alkyl wherein the C(1-3)alkoxy is optionally substituted with one hydroxyl group or methyl ester,
   C(2)alkyl substituted with one hydroxyl group or one methyl ester,
   C(3-5)alkyl substituted with one hydroxyl group and one methyl ester,
   C(3-5)alkyl substituted with one or two hydroxyl groups, or
   C(3-5)alkyl substituted with one or two methyl esters, and
   one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids, or a salt thereof, in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition),
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition);
wherein the disinfecting composition has a pH of from 1.5 to 3.0, and optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % of (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % of (calculated on the total weight of the composition);
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more non-ethoxylated anionic surfactants in a total amount of from 0.2 to 20 wt. % (calculated on the total weight of the composition);
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition); and
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 0.2 to 7.0 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition);
f) from 0.01 to 2.0 wt. % of a hydrogen peroxide stabilizer (calculated on the total weight of the composition);
g) one or more acids in a total amount of from 0.1 to 2.0 wt. % of (calculated on the total weight of the composition);
wherein the disinfecting composition has a pH of from 1.5 to 3.0, and
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) one or more compounds according to formula Ia, R^{a}C(═O)OR^{b}, wherein
   R^{a} is C(6)aryl optionally substituted with hydroxyl, and R^{b} is a C(1-6)alkyl or C(6)aryl-(C1-2)alkyl, or
   R^{a} is C(6)aryl-C(1-2)alkyl and R^{b} is C(6)aryl optionally substituted with methyl or C(1-6)alkyl optionally substituted with C(6)aryl,
   in a total amount of from 0.1 to 10.0 wt. % (calculated on the total weight of the composition), in particular from 0.3 to 10.0 wt. %, more in particular from 0.5 to 10.0 wt. %, even more in particular from 1.0 to 10.0 wt. %;
b) from 7.5 to 15 wt. % of hydrogen peroxide (calculated as the net weight of hydrogen peroxide on the total weight of the composition);
c) one or more N-acylated amino acids, or a salt thereof, in a total amount of from 0.01 to 10 wt. % (calculated on the total weight of the composition);
d) one or more salts of a compound according to formula II, R²—(O—CH₂—CH₂)ₘ—O—SO₃, wherein R² is C(8-18)alkyl and m is 2-6, in a total amount of from 0.2 to 20 wt. % (calculated on the total weight of the composition),
e) from 0.01 to 2.0 wt. % of a hydrogen peroxide stabilizer (calculated on the total weight of the composition);
f) one or more acids in a total amount of from 0.1 to 2.0 wt. % (calculated on the total weight of the composition);
wherein the disinfecting composition has a pH of from 1.5 to 3.0, and optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

The disinfecting composition disclosed herein may comprise:
a) from 0.1 to 1.5 wt. % of triacetin (calculated on the total weight of the composition);
b) from 0.5 to 2.0 wt. % of hydrogen peroxide (calculated as the net weight of hydrogen peroxide on the total weight of the composition);
c) one or more N-acylated amino acids or salts thereof, optionally wherein the N-acylated amino acid is one or more selected from the group consisting of N-lauroyl sarcosine, N-myristoyl sarcosine, N-cocoyl sarcosine, N-oleoyl sarcosine, N-stearoyl sarcosine, sodium lauroyl sarcosinate, sodium myristoyl sarcosinate, sodium cocoyl sarcosinate, sodium oleoyl sarcosinate, sodium stearoyl sarcosinate, N-lauroyl glycine, N-myristoyl glycine, N-cocoyl glycine, N-oleoyl glycine, N-stearoyl glycine, sodium lauroyl glycinate, sodium myristoyl glycinate, sodium cocoyl glycinate, sodium oleoyl glycinate, sodium stearoyl glycinate, N-lauroyl glutamine, N-myristoyl glutamine, N-cocoyl glutamine, N-oleoyl glutamine, N-stearoyl glutamine, sodium lauroyl glutamate, sodium myristoyl glutamate, sodium cocoyl glutamate, sodium oleoyl glutamate, sodium stearoyl glutamate, sodium N-cyclohexyl-N-palmitoyltaurate, sodium N-cis-1-oxo-9-octadecenyl-N-methyltaurine, sodium N-palmitoyl-N-methyltaurine, sodium N-lauroyl-N-methyltaurine, sodium N-cis-9-octadecenyl-N-methyltaurine, and salts thereof, in particular N-cocoyl sarcosine or a salt thereof
   in a total amount of from 0.3 to 1.0 wt. % (calculated on the total weight of the composition);
d) one or more non-ethoxylated anionic surfactants in a total amount of from 0.5 to 1.5 wt. % (calculated on the total weight of the composition),
e) one or more acids in a total amount of from 0.1 to 2.0 wt. % (calculated on the total weight of the composition), optionally wherein the one or more acids comprise benzoic acid and/or salicylic acid;
f) solvent selected from the group consisting of propylene glycol methyl ether, dipropylene glycol methyl ether, tripropylene glycol methyl ether, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, dipropylene glycol phenyl ether, dipropylene glycol dimethyl ether, diethylene glycol methyl ether, triethylene glycol methyl ether, diethylene glycol ethyl ether, triethylene glycol ethyl ether, ethylene glycol propyl ether, ethylene glycol n-butyl ether, diethylene glycol n-butyl ether, triethylene glycol n-butyl ether, ethylene glycol hexyl ether, diethylene glycol hexyl ether, ethylene glycol phenyl ether, and diethylene glycol phenyl ether
   in a total amount of from 0.1 to 3.0 wt. % (calculated on the total weight of the composition)
wherein the disinfecting composition has a pH of from 1.5 to 2.5,
optionally wherein the disinfecting composition comprises a percarboxylic acid or a precursor thereof,
optionally wherein the disinfecting composition comprises less than 0.1 wt. % of a C3-C6 N-alkyl-gamma-butyrolactam (calculated on the total weight of the composition),
optionally wherein the disinfecting composition comprises less than 0.1 wt. % of a perhydrolase (calculated on the total weight of the composition),
optionally wherein the disinfecting composition comprises less than 3.0 wt. % of benzyl alcohol (calculated on the total weight of the composition).

### Applications of the Disinfecting Composition

The disinfecting composition according to the disclosure is surprisingly effective against bacteria (e.g., Staphylococcus aureus, Salmonella typhimurium, Pseudomonas aeruginosa, Escherichia coli), fungi (e.g. Candida auris) and viruses (e.g., Norovirus, Feline Calicivirus). Accordingly, it may find use in both medical and non-medical applications. The disinfecting composition is particularly effective in killing bacteria, fungi and viruses on hard and soft innate surfaces, with short contact times.

The disinfecting composition of the disclosure are particularly effective to be used in a pre-impregnated towelette to disinfect hard surfaces with short contact times.

Furthermore, the disinfecting composition may further be used in treating a skin infection. In particular, the disinfecting composition according to the disclosure may be for treating a skin infection caused by bacteria or fungi, such as Staphylococcus aureus, Candida auris, Salmonella typhi, Pseudomonas aeruginosa, or Escherichia coli, more in particular Staphylococcus aureus or Candida auris.

Also disclosed herein is a method of disinfecting a surface comprising applying the disinfecting composition according to the disclosure to the surface. The surface may be a metal surface, a lacquered surface, a veneered surface, a painted surface, a glass surface, or plastic surface, such as the surfaces of tabletops, doorknobs, floors, doors, television remote controls, computer keyboards and other frequently touched objects that may participate in germ transmission. The surface may, in particular, comprise (or be made of) a material selected from the group of poly(methyl methacrylate) (PMMA), high or low density polyethylene (HDPE or LDPE), acrylonitrile butadiene styrene (ABS), acrylic polyvinyl chloride, polypropylene (PP), polycarbonate (PC), polyethylene terephthalate (PETG), and stainless steel. The method of disinfecting a surface may be a non-therapeutic method.

The method of disinfecting a surface may comprise applying the disinfecting composition to the surface with a towelette comprising the disinfecting composition. The disinfecting composition may be applied for a period of from 30 seconds to 10 minutes, in particular for a period of from 40 seconds to 3 minutes, more in particular for a period of from 50 seconds to 1.5 minutes.

The disinfecting composition according to the disclosure is surprisingly suitable for application with a preimpregnated towelette. Accordingly, the disinfecting composition may be included within a towelette. Thus, disclosed herein is also a towelette comprising the disinfecting composition according to the disclosure. A towelette may consist of a sheet-like substrate impregnated with a liquid composition, in the present case the disinfecting composition according to the disclosure.

Suitable substrates for towelettes are well-known in the art and include woven and non-woven sheets of a fibrous material with sufficient wet strength and liquid absorption capacity to contain a suitable amount of the liquid composition according to the invention and deliver it to the surface to be cleaned. The fibres in the fibrous material may be from natural sources e.g. viscose or cellulose such as wood pulp or cotton, or cellulose fibres from paper, bamboo, wheatgrass, carton, etc. or synthetic origin such as polypropylene (PP), polyethylene (PE), or polyethyleneterephtalate (PET). Combinations of materials may also be used. Optionally, the substrate may comprise one or more polymeric binders. Any binder material present should not be soluble in the liquid composition to such an extent that it causes the towelette to cause streaking on the cleaned surface. The substrate can be manufactured by methods known in the art which require no elucidation here.

The towelette may be a single layer structure or a multilayer structure, wherein the layers may be the same or different. In one embodiment, prior to impregnation with the composition described herein, the towelette has an average thickness ranging from 0.1 to 3.0 mm, preferably from 0.2 to 1.0 mm, more preferably from 0.3 to 0.6 mm. Prior to impregnation with the composition of the invention, the towelette typically has a baseweight of from 20 to 100 g/m², preferably from 30 to 90 g/m², more preferably from 40 to 80 g/m². The composition described herein is impregnated in a ratio of typically between 200% and 500% of liquid weight to the weight of the towelette substrate, preferably 220%-450%, depending on the material of the towelette.

The composition can also be applied by spraying and/or flooding the surface with the disinfectant composition or by immersion of (e.g., medical) items in the use solution. However, the preferred method of application is to use the composition in an impregnated towelette, as disclosed above. Towelettes are used to clean a surface through light rubbing or friction. One of the main benefits that towelettes provide is convenience-using a towelette is quicker and easier than the alternative of dispensing a liquid and using another cloth/paper towel to clean or remove the liquid.

As will be evident to the skilled person, different embodiments of the present invention can be combined unless they are mutually exclusive.

The present disclosure also contemplates the possibility of omitting any of components listed herein. The present disclosure further contemplates the omission of any components even though they are not expressly named as included or excluded from the disclosure. For example, the present disinfecting compositions can be substantially free of compounds or ingredients not expressly recited. As used herein, a disinfecting composition that is “substantially free of” one or more ingredients means that the disinfecting composition includes no more than trace or incidental amounts of those ingredients. Trace or incidental amounts of an ingredient can be found in another ingredient as an impurity or as a by-product of a side reaction during formation or degradation of a component of the composition. For the sake of clarity, ingredients present in a trace or incidental amount will not be present in excess of 0.5 wt. % based on the total weight of the composition, in particular not in excess of 0.3 wt. %, more in particular not in excess of 0.1 wt. %, more in particular not in excess of 0.01 wt. %.

### Definitions, Etc.

As used herein, “C(x)alkyl” refers to an alkyl group having x carbon atoms in a linear or branched arrangement. For example, the term “C(6)alkyl” refers to a hexyl group.

As used herein, “C(x-y)alkyl” refers to an alkyl group having x to y carbon atoms in a linear or branched arrangement. For example, the term “C(1-5)alkyl” refers to an alkyl having 1 to 5 carbon atoms, i.e. to methyl, ethyl, propyl, butyl, and pentyl groups. As another example, the term “C(6-16)alkyl” refers to an alkyl group having 6 to 16 carbon atoms, so to hexyl, heptyl, octyl, nonyl, decyl, undecyl, dodecyl, tridecyl, tetradecyl, pentadecyl, and hexadecyl groups.

As used herein, “C(x-y)alkenyl” refers to an alkenyl group having x to y carbon atoms in a linear or branched arrangement. For example, the term “C(2-3)alkenyl” refers to an alkenyl group having 2 or 3 carbon atoms, i.e. to ethenyl, 1-propenyl, or 2-propenyl groups.

As used herein, “C(x)alkoxy” refers an alkyl group having x carbon atoms attached through an oxygen linking atom. For example, “C(1)alkoxy” refers to an alkyl group having 1 carbon atoms (i.e., methyl) attached through an oxygen linking atom, so to a methoxy group.

As used herein, “C(x-y)alkoxy” refers an alkyl group having x to y carbon atoms attached through an oxygen linking atom. For example, “C(1-3)alkoxy” refers to an alkyl group having one to three carbon atoms (i.e., methyl, ethyl, (iso-) propyl) attached through an oxygen linking atom, so to a methoxy, ethoxy or (iso-) propoxy group.

As used herein, “C(x₁-y₁)alkoxy-C(x₂-y₂)alkyl” refers to a “C(x₁-y₁)alkoxy” group attached to a C(x₂-y₂)alkyl group, both with the same meaning as previously defined. The number of carbon atoms of the C(x-y)alkoxy group and the C(x-y)alkyl group are independent. For example, the term “C(1-5)alkoxy-C(1-5)alkyl” refers to a C(1-5)alkoxy group attached to a C(1-5)alkyl group.

As used herein, “C(x₁-y₁)alkoxy-C(x₂-y₂)alkoxy-C(x₃-y₃)alkyl” refers to a “C(x₁-y₁)alkoxy” group attached to a “C(x₂-y₂)alkoxy” group, which is attached to a C(x₃-y₃)alkyl group, all with the same meaning as previously defined. The number of carbon atoms of the C(x-y)alkoxy groups and the C(x-y)alkyl group are independent. For example, the term “C(1-3)alkoxy-C(1-5)alkoxy-C(1-5)alkyl” refers to a C(1-3)alkoxy group attached to a C(1-5)alkoxy group, which is attached to a C(1-5)alkyl group.

As used herein, “C(x-y)alkylalcohol” refers to alkyl groups having x to y carbon atoms substituted with one hydroxyl groups. For example, “C(2-3)alcohol” can refer to ethanol, propanol, vinylalcohol, and allylalcohol.

As used herein, “C(x-y)alkenyl” refers to an alkenyl group having x to y carbon atoms. For example, “C(2-3)alkenyl” can refer to ethenyl, 1-propenyl and 2-propenyl groups.

As used herein, “C(x-y)alkynyl” refers to an alkynyl group having x to y carbon atoms. For example, “C(2-3)alkenyl” can refer to ethylyl, 1-propynyl and 2-propynyl.

As used herein, “C(x)aryl” refers to an aryl group having x carbon atoms. For example, “C(6)aryl” refers to phenyl.

As used herein, “C(4-5)heteroaryl” refers to an heteroaryl group having 4 or 5 carbon atoms and 2 or 1 heteroatoms, respectively. The heteroatom is preferably a nitrogen atom. Examples include pyridinyl, pyrimidinyl, and pyrazinyl.

As used herein, “C(x-y)cycloalkyl” refers to a saturated or partially unsaturated cycloalkyl group having x to y carbon atoms. For example, “C(5-8)cycloalkyl” can refer to cyclopentyl, cyclohexyl, cycloheptyl, cyclooctyl, and cyclooctenyl.

As used herein, “C(x₁)aryl-C(x₂-y₂)alkyl” refers to an aryl group having x₁ carbon atoms, which is attached to an alkyl group having x₂ to y₂ carbon atoms. For example “C(6)aryl-C(1-2)alkyl” refers to a phenyl group, which is attached to a methyl group or an ethyl group.

As used herein, “C(x₁-y₁)heteroaryl-C(x₂-y₂)alkyl” refers to refers to an an heteroaryl group having 4 or 5 carbon atoms and 2 or 1 heteroatoms, respectively, which is attached to an alkyl group having x₂ to y₂ carbon atoms. For example “C(4-5)heteroaryl-C(1-2)alkyl” can refer to a pyridinyl, pyrimidinyl, or pyrazinyl group, which is attached to a methyl group or an ethyl group.

All percentages used herein are weight percentages, unless specified otherwise. In addition, unless specified otherwise, the weight percentages are calculated using the net weight of a particular component and the total weight of the disinfecting composition.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

### EXAMPLES

The following examples will illustrate the practice of the disclosed embodiments. Other embodiments within the scope of the claims will be apparent to one skilled in the art.

### Example 1: Antimicrobial Activity of the Disinfecting Compositions

To test bactericidal efficacy, a towelette test was performed following to the Germicidal Towelette Method/AOAC Official Method 961.02, which is a modification of the AOAC Germicidal Spray Products as Disinfectants Test 961.02 for pre-saturated towelettes. The test evaluates the effectiveness of towelette products as disinfectants for contaminated surfaces and meets the requirements of the EPA OCSPP 8102000 and 810.2200 Product Performance Test Guidelines (February 2018), and Health Canada's “Guidance Document—Safety and Efficacy Requirements for Surface Disinfectant Drugs” (April 2020) and “Guidance Document-Disinfectant Drugs” (April 2020).

Briefly, glass microscope slides as carriers were sterilized prior to use. The carriers were then inoculated with approximately 105 colony forming units (CFU) per carrier of Staphylococcus aureus (S. aureus) as indicated, by spreading a culture of the respective bacterium over the surface of the carrier. The carriers were allowed to dry. Then, each carrier was wiped at room temperature with a towelette impregnated with a test composition as indicated in Tables 1 or 2. The towelette was held in contact with the carrier for the time indicated in the Tables. Per test composition, 60 replicates were performed using one lot of each test composition. After wiping, the carrier was transferred to a neutralizing recovery medium, incubated for 48 hours at 37° C. in broth and observed for visible bacterial growth. Controls as described in AOAC Official Method 961.02 were also included. Absence of microbial growth or turbidity in the broth in substantially all replicates (preferably in 57 or more replicates, more preferably in 59 or 60 replicates) was considered a “pass” of the test.

To test virucidal efficacy, a test following the procedure outlined in the ASTM International test method designated E1053-20, “Standard Practice to Assess Virucidal Activity of Chemicals Intended for Disinfection of Inanimate, Nonporous Environmental Surfaces”, was performed. This test is designed to simulate consumer use and determines the potential of the test substance to disinfect hard surfaces contaminated with the test virus. The test conforms to EPA OCSPP 810.2000 (2018) and 810.2200 (2018) Product Performance Test Guidelines, OCSPP 8102000, 810.2100 and 810.2200, and to Health Canada's “Guidance Document-Safety and Efficacy Requirements for Surface Disinfectant Drugs” (April 2020) and “Guidance Document-Disinfectant Drugs” (April 2020).

Briefly, Feline Calicivirus (FCV) is dried on sterile glass Petri dishes as carriers at room temperature. A 10 square inch surface area of each carrier was wiped with a towelette impregnated with a disinfecting composition as indicated in Table 1. The towelette was held in contact with the carrier for 50 seconds. After wiping, the bottom of the carrier is scraped to resuspend the virus. The resuspended virus is passed through a gel filtration column for neutralization. The log reduction of the feline calicivirus titer was determined as described in ASTM E1053-20. A log reduction of the feline calicivirus titer of >3 is indicative of a total kill. Controls as described in ASTM E1053-20 were also included.

Example disinfecting compositions were prepared using, amongst others, the ingredients as described in the table below.

| Ingredient name | Description |
|---|---|
| Glucopon 215 | Alkyl glucoside based on a short-chain (C8) |
| | fatty alcohol and glucose |
| AG6206 | Alkyl glucoside based on a short-chain (C6) |
| | fatty alcohol and glucose |
| Dehyton AB 30 | Coco-betaine |
| Baypure CX100 | Tetrasodium iminodisuccinate |
| Interox CO-35 | Hydrogen peroxide |
| Crodasinic LS95 | Sodium lauroyl sarcosinate |
| Crodasinic C | Cocoyl sarcosine |
| Texapon K12 | Sodium C12 fatty alcohol sulphate |
| Texapon 842 | Sodium C8 fatty alcohol sulphate |
| Hoesch AE50 | Sodium dodecylbenzene sulphonate |
| Bio-soft S-101 | C11.3 linear alkylbenzene sulphonic acid |
| Sulfonax | Dodecylbenzene sulfonic acid |
| Stepanate SXS-93 | Sodium xylene sulphonate |
| Bioterge PAS 8S | Sodium caprylyl sulphonate |
| Dowanol PMA | Propylene glycol methyl ether acetate |
| Dowanol PnB | Propylene glycol n-butyl ether |
| Ingredient name | Description |
| Triacetin | Glycerol triacetate |
| Dowanol PGDA | Propylene glycol diacetate |
| Dowanol TPM | Tripropylene glycol methyl ether |
| Monafax 1214 | Aliphatic phosphate ester (C8-10 and 4EO) |
| Lutensol XL80 | C10 alcohol ethoxylate |
| | (C10-guerbet alcohol alkoxylates, 8EO) |
| Dissolvine GL-47-S | Glutamic acid, N,N-diacetic acid, tetrasodium |
| | salt (GLDA) |
| Pluronic PE 6200 | PO-EO-block polymer (approx. 20% polyethylene |
| | glycol in molecule) |
| Ethylan 1005 | C10, 5 EO Alcohol alkoxylate |
| Protelan AG 8 | Sodium capryloyl glutamate |
| Tego Betaine F50 | Cocoamidopropyl betaine |
| Zetesol Zn | Zinc coceth sulphate |

In the Tables below, the weight percentages of each active are calculated using the net weight of a particular component and the total weight of the disinfecting composition.

Table 1 discloses the activity of disinfecting compositions according to the disclosure against S. aureus:

TABLE 1
Activity of disinfecting compositions against S. aureus

| Sample no.: | 1 | 2 | 3 | 4 | 5 | 6 | 7 |
|---|---|---|---|---|---|---|---|
| Water | 91.58 | 91.95 | 90.46 | 92.08 | 90.25 | 90.26 | 90.04 |
| Phosphoric acid | 0.66 | 0.29 | 0.68 | 0.62 | 0.36 | 0.35 | 0.27 |
| Glucapon 215 | — | — | — | — | 0.063 | 0.063 | 0.063 |
| AG6206 | 0.075 | 0.075 | 0.38 | 0.075 | — | — | 0.15 |
| Baypure CX100 | 0.05 | 0.05 | 0.05 | 0.05 | 0.05 | 0.05 | 0.05 |
| Interox CO-35 | 1.00 | 1.00 | 1.00 | 0.70 | 1.40 | 1.40 | 1.40 |
| Crodasinic LS95 | 0.10 | 0.10 | 0.19 | 0.19 | 0.19 | 0.19 | 0.19 |
| Texapon K12 | 0.38 | 0.38 | 0.48 | 0.19 | 0.29 | 0.19 | — |
| Texapon 842 | — | — | 0.48 | 0.48 | — | — | — |
| Hoesch AE50 | — | — | — | — | 0.25 | 0.20 | 0.20 |
| Stepanate SXS-93 | — | — | — | — | — | 0.080 | 0.080 |
| Bioterge PAS 8S | — | — | — | — | — | — | 0.11 |
| Dowanol PMA | 2.00 | 2.00 | 2.00 | 2.00 | 2.00 | 2.00 | 2.00 |
| Triacetin | — | — | 1.00 | 2.00 | 1.00 | 1.00 | 1.00 |
| Dowanol PGDA | 1.00 | 1.00 | — | 2.00 | — | — | 1.00 |
| Dowanol TPM | 1.00 | 1.00 | 1.00 | — | 1.00 | 1.00 | — |
| Salicylic acid | — | 0.20 | — | — | 0.20 | 0.20 | 0.20 |
| Sodium benzoate | 0.20 | — | 0.20 | 0.20 | — | — | — |
| pH | 2.0 | 2.0 | 2.0 | 2.0 | 2.0 | 2.0 | 2.0 |
| Activity against S. aureus | 0/60 | 1/60 | 1/60 | 0/60 | 0/60 | 1/60 | 0/60 |
| (60 s contact time) | | | | | | | |

| Sample no.: | 8 | 9 | 10 | 11 | 12 | 13* | 14* |
|---|---|---|---|---|---|---|---|
| Water | 90.20 | 92.82 | 92.92 | 93.27 | 92.40 | 93.51 | 94.27 |
| Phosphoric acid | 0.36 | 0.36 | — | 0.46 | 0.83 | 0.35 | — |
| Methane sulphonic acid | — | — | — | — | — | — | 0.10 |
| Sulphamic acid | — | — | 0.16 | — | — | — | — |
| Glucapon 215 | 0.063 | — | 0.13 | — | — | — | — |
| AG6206 | — | — | — | 0.08 | 0.38 | 0.38 | 0.38 |
| Dehyton AB 30 | 0.030 | 0.060 | 0.060 | 0.030 | — | — | — |
| Baypure CX100 | 0.05 | 0.05 | 0.05 | 0.05 | 0.05 | 0.05 | 0.05 |
| Interox CO-35 | 1.40 | 0.50 | 0.50 | 0.20 | 0.20 | 0.049 | 0.049 |
| Lactic acid (46%) | — | — | — | 0.37 | — | — | — |
| Tartaric acid (100%) | — | — | — | — | 0.20 | — | — |
| Crodasinic LS95 | 0.19 | 0.19 | 0.19 | 0.10 | 0.19 | 0.19 | 0.19 |
| Texapon K12 | 0.29 | 0.29 | 0.19 | 0.38 | 0.48 | 0.48 | — |
| Texapon 842 | — | — | — | — | 0.48 | 0.48 | — |
| Hoesch AE50 | 0.10 | 0.15 | 0.10 | — | — | — | — |
| Bio-soft S-101 | — | — | — | — | — | — | 0.19 |
| Stepanate SXS-93 | — | 0.12 | 0.080 | — | — | — | — |
| Bioterge PAS 8S | 0.095 | — | 0.076 | — | — | — | — |
| Dowanol PMA | 3.00 | 2.00 | 2.00 | 2.00 | 2.00 | 2.00 | 2.00 |
| Triacetin | 1.00 | 1.00 | 1.00 | — | 1.00 | 1.00 | — |
| Dowanol PGDA | — | — | — | 1.00 | — | — | 2.00 |
| Dowanol TPM | 1.00 | — | 1.00 | 1.00 | 1.00 | 1.00 | — |
| Salicylic acid | 0.20 | 0.20 | 0.20 | — | — | 0.20 | 0.20 |
| Sodium benzoate | — | — | — | 0.20 | 0.20 | — | — |
| pH | 2.0 | 2.0 | 2.0 | 2.0 | 2.0 | 2.0 | 2.0 |
| Activity against S. aureus | 1/60 | 0/60 | 1/60 | 1/60 | 1/60 | 10/60 | 35/60 |
| (60 s contact time) | | | | | | | |

*These samples are not according to the disclosure; comparative samples 13-14 comprised less than 0.2 wt. % of hydrogen peroxide.

The results demonstrate that the disinfecting compositions are surprisingly effective against S. aureus in the standardized towelette tests of the regulatory authorities. The disinfecting compositions in Table 1 would all pass these particularly hard-to-pass tests.

The disinfecting compositions in Table 1 generally contain a compound according to formula I (Dowanol PMA, triacetin, and/or propylene glycol diacetate), hydrogen peroxide, a non-ethoxylated anionic surfactant, and a salt of an N-acylated amino acid (Crodasinic LS95). Each of the disinfecting compositions evaluated resulted in a (near) total kill of both S. aureus after a contact time of just 60 seconds.

It has been found that the amount of hydrogen peroxide in the composition should not be lower than 0.1 wt. %, as samples 13 and 14 contained 0.049 wt. % of hydrogen peroxide (net weight based on the total weight of the composition) and were far less active than the compositions according to the disclosure.

### Example 2: Antimicrobial Activity Against S. aureus and Feline Calicivirus

Having established that the disinfecting compositions according to the disclosure have a surprisingly good activity against S. aureus in the towelette tests, variations of the disinfecting compositions were made and evaluated. Particularly, combinations of solvents, amounts of components, and pH were varied. The antimicrobial activity of the resulting disinfecting compositions was evaluated against S. aureus and Feline Calicivirus using the towelette tests described in Example 1.

Tables 2a-d disclose the activity of disinfecting compositions according to the disclosure against S. aureus and Feline Calicivirus:

TABLE 2a
Activity of disinfecting compositions S. aureus and Feline Calicivirus

| Sample no.: | 15 | 16 | 17 | 18 | 19 | 20 |
|---|---|---|---|---|---|---|
| Water | 91.74 | 93.09 | 91.72 | 91.36 | 92.35 | 94.13 |
| Methane sulphonic acid | 0.36 | 0.41 | — | 0.44 | 0.45 | — |
| Sulfamic acid | — | — | 0.28 | — | — | 0.70 |
| AG 6206 | 0.075 | 0.075 | 0.075 | 0.23 | 0.23 | 0.38 |
| Baypure CX100 | 0.017 | 0.017 | 0.017 | 0.017 | 0.017 | 0.017 |
| Interox CO-35 | 1.40 | 1.40 | 1.40 | 1.40 | 1.40 | 0.20 |
| Crodasinic LS95 | 0.095 | 0.19 | 0.19 | 0.19 | 0.19 | 0.95 |
| Texapon K12 | 0.38 | 0.38 | 0.38 | 0.38 | 0.38 | 1.90 |
| Dowanol PMA | 2.00 | 0.50 | 2.00 | 2.00 | — | 0.50 |
| Triacetin | — | — | 1.00 | — | — | 0.30 |
| Dowanol PGDA | 1.00 | 1.00 | — | 1.00 | 2.00 | — |
| Sodium benzoate | 0.20 | 0.20 | 0.20 | 0.20 | 0.20 | 0.20 |
| PH | 2.0 | 2.0 | 2.0 | 2.0 | 2.0 | 2.0 |
| Activity against S. aureus | 1/60 | 0/60 | 1/60 | 1/60 | 1/60 | 1/60 |
| (50 s contact time) | | | | | | |
| Activity against FCV (log | n.d. | n.d. | >3 | n.d. | n.d. | n.d. |
| reduction after 50 s | | | | | | |
| contact time) | | | | | | |

n.d., not determined.

TABLE 2b
Activity of disinfecting compositions against S. aureus and Feline Calicivirus

| Sample no.: | 21 | 22 | 23 | 24 | 25 | 26* |
|---|---|---|---|---|---|---|
| Water | 91.45 | 91.33 | 92.85 | 93.14 | 91.16 | 91.17 |
| Methane sulphonic acid | — | 0.47 | 0.45 | — | 0.45 | 0.43 |
| Sulfamic acid | 0.36 | — | — | 0.36 | — | — |
| Glucopon 215 | 0.065 | 0.065 | 0.065 | 0.065 | — | — |
| AG 6206 | 0.15 | 0.15 | 0.15 | 0.15 | 0.15 | 0.15 |
| Baypure CX100 | 0.017 | 0.017 | 0.017 | 0.017 | 0.017 | 0.017 |
| Interox CO-35 | 1.40 | 1.40 | 1.40 | 1.40 | 1.40 | 1.40 |
| Crodasinic LS95 | 0.19 | 0.19 | 0.19 | 0.19 | 0.19 | 0.19 |
| Hoesch AE50 | 0.20 | 0.20 | 0.20 | 0.20 | 0.20 | 0.20 |
| Bioterge PAS 8S | — | — | — | 0.076 | 0.11 | 0.11 |
| Dowanol PMA | 2.00 | 2.00 | — | — | 2.00 | — |
| Triacetin | 1.00 | — | 0.50 | — | 1.00 | — |
| Dowanol PGDA | — | 1.00 | 1.00 | 1.00 | — | — |
| Dowanol TPM | — | — | — | — | — | 3.00 |
| Sodium benzoate | 0.20 | 0.20 | 0.20 | 0.20 | 0.20 | 0.20 |
| pH | 2.0 | 2.0 | 2.0 | 2.0 | 2.0 | 2.0 |
| Activity against S. aureus | 1/60 | 0/60 | 1/60 | 0/60 | 1/60 | 14/60 |
| (50 s contact time) | | | | | | |
| Activity against FCV (log | n.d. | >3 | >3 | >3 | n.d. | n.d. |
| reduction after 50 s | | | | | | |
| contact time) | | | | | | |

*This sample is not according to the disclosure; comparative sample 26 did not contain a compound according to formula I.
n.d., not determined.

TABLE 2c
Activity of disinfecting compositions against S. aureus

| Sample no.: | 27 | 28 | 29 | 30 | 31 |
|---|---|---|---|---|---|
| Water | 88.15 | 93.06 | 87.54 | 93.20 | 90.94 |
| Methane sulphonic | 0.55 | — | 0.66 | — | 0.46 |
| acid | | | | | |
| Sulfamic acid | — | 0.57 | — | 0.57 | — |
| AG 6206 | 0.38 | 0.38 | 0.38 | 0.38 | 0.075 |
| Baypure CX100 | 0.017 | 0.017 | 0.017 | 0.017 | 0.017 |
| Interox CO-35 | 2.10 | 0.20 | 1.40 | 0.50 | 1.40 |
| Crodasinic LS95 | 0.48 | 0.95 | 0.95 | 0.95 | 0.19 |
| Texapon K12 | 0.48 | 0.48 | 0.95 | 0.95 | 0.38 |
| Texapon 842 | 0.48 | 0.48 | 0.95 | 0.95 | 0.38 |
| Dowanol PMA | 2.00 | 1.00 | 2.00 | 0.50 | 1.00 |
| Triacetin | 1.00 | 1.00 | 1.00 | 0.50 | — |
| Dowanol PGDA | — | 1.00 | 1.00 | — | 0.20 |
| Sodium benzoate | 0.20 | 0.20 | 0.20 | 0.20 | 0.20 |
| pH | 2.0 | 2.0 | 3.0 | 2.0 | 2.0 |
| Activity against | 1/60 | 1/60 | 0/60 | 0/60 | 0/60 |
| S. aureus (50 s | | | | | |
| contact time) | | | | | |

TABLE 2d
Activity of disinfecting compositions against S. aureus

| Sample no.: | 32 | 33 |
|---|---|---|
| Water | 91.50 | 88.43 |
| Phosphoric acid | — | 0.13 |
| Methanesulfonic acid | 0.20 | — |
| AG6206 | 0.15 | 0.15 |
| Interox CO-35 | 1.00 | 1.40 |
| Sodium lauryl ether sulphate | 2.00 | 4.00 |
| Crodasinic LS95 | 0.19 | 0.19 |
| Dowanol PMA | 2.00 | 2.00 |
| Triacetin | 1.00 | — |
| Dowanol PGDA | — | 1.00 |
| Sodium benzoate | 0.20 | 0.20 |
| pH | 3.0 | 4.0 |
| Activity against S. aureus | 1/60 | 3/60 |
| (50 s contact time) | | |

The results demonstrate that the disinfecting compositions according to the disclosure are surprisingly active against S. aureus and Feline Calicivirus, a Norovirus surrogate. All disinfecting compositions—despite containing different (amounts of) solvent combinations, surfactants, acids, hydrogen peroxide, and having different pH values-passed the stringent requirements for the towelette tests described in the Germicidal Towelette Method/AOAC Official Method 961.02 and ASTM E1053-20.

Without wishing to be bound by theory, it is believed the surprising antimicrobial activity is associated with the specific combination of compounds used in and features of the compositions according to the disclosure (in particular, the combination of the compound according to formula I, the hydrogen peroxide, the N-acylated amino acid or salt thereof, the non-ethoxylated anionic surfactant or the compound according to formula II, and the pH).

### Example 3: Antimicrobial Activity of Compositions with Different Solvents

To demonstrate the effect the compound according to formula I has on the antimicrobial activity of the compositions against S. aureus and Feline Calicivirus, various compositions were prepared using different solvents and evaluated using the towelette tests described in Example 1.

TABLE 3
Activity of disinfecting compositions against
S. aureus and Feline Calicivirus

| Sample no.: | 34 | 35 | 36* | 37 | 38* |
|---|---|---|---|---|---|
| Water | 93.35 | 91.87 | 93.74 | 90.75 | 90.74 |
| Methane sulphonic | 0.45 | — | 0.46 | 0.45 | 0.46 |
| acid | | | | | |
| Sulfamic acid | — | 0.33 | — | — | — |
| AG 6206 | 0.23 | 0.23 | 0.23 | 0.23 | 0.23 |
| Baypure CX100 | 0.017 | 0.017 | 0.017 | 0.017 | 0.017 |
| Interox CO-35 | 1.40 | 1.40 | 1.40 | 1.40 | 1.40 |
| Crodasinic LS95 | 0.19 | 0.19 | 0.19 | 0.19 | 0.19 |
| Texapon K12 | 0.38 | 0.48 | 0.48 | 0.48 | 0.48 |
| Texapon 842 | — | 0.48 | 0.48 | 0.48 | 0.48 |
| Dowanol PMA | 0.50 | 1.00 | — | — | — |
| Dowanol PGDA | 0.50 | 1.00 | — | — | — |
| Dowanol TPM | — | — | — | 3.00 | — |
| Ethanol | — | — | — | — | 3.00 |
| Sodium benzoate | 0.20 | 0.20 | 0.20 | 0.20 | 0.20 |
| pH | 2.0 | 2.0 | 2.0 | 2.0 | 2.0 |
| Activity against | 1/60 | 1/60 | 10/60 | 24/60 | 18/60 |
| S. aureus (50 s | | | | | |
| contact time) | | | | | |
| Activity against | >3 | >3 | n.d. | n.d. | n.d. |
| FCV (log reduction | | | | | |
| after 50 s | | | | | |
| contact time) | | | | | |

*These samples are not according to the disclosure; comparative samples 36-38 did not contain a compound according to formula I.

The results demonstrate that the disinfecting composition is surprisingly effective against S. aureus and Feline Calicivirus in the standardized towelette tests required for a disinfection claim when registering with the regulatory authorities. Samples 34 and 35 contained compounds according to formula I and were found to pass these notoriously hard-to-pass tests. When the compounds according to formula I were removed from the disinfecting composition, the resulting composition (sample 36) was significantly less active and failed to pass the same towelette tests. And when the compounds according to formula I were replaced with commonly used solvents (as in samples 37 and 38), the resulting compositions were even less active and also failed to pass the towelette tests.

### Example 4: Antimicrobial Activity of Compositions Described in the Art

Compositions described in the art were made and their antimicrobial activity was determined as described in Example 1. The results are summarized in Table 4:

TABLE 4
Activity against S. aureus of compositions described in the art

| Sample no.: | 39* | 40* | 41* |
|---|---|---|---|
| Water | 90.31 | 87.27 | 96.03 |
| Monafax 1214 | — | 0.61 | 0.48 |
| Phosphoric acid | — | — | 0.06 |
| Methane sulphonic acid | 0.20 | — | — |
| Lutensol XL80 | — | — | 0.60 |
| Acetanilide | — | — | 0.50 |
| Glucopon 215 | — | — | 0.065 |
| Baypure CX100 | — | — | 0.017 |
| Interox CO-35 | 1.00 | 2.50 | 0.50 |
| Bioterge PAS 8S | 0.05 | — | — |
| Dissolvine GL-47-S | 0.09 | — | — |
| Pluronic PE 6200 | 0.33 | — | — |
| Ethylan 1005 | 0.33 | — | — |
| Protelan AG 8 | — | 0.72 | — |
| Crodasinic LS95 | 0.17 | — | — |
| Stapanate SXS-93 | 0.14 | — | — |
| Tego Betaine F50 | — | 0.72 | — |
| Zetesol Zn | — | 0.25 | — |
| Disodium EDTA | — | 0.10 | — |
| Dowanol TPM | 3.00 | — | — |
| pH | 3.0 | 4.2 | 4.5 |
| Activity against S. aureus | 49/60 | 59/60 | 60/60 |
| (60 s contact time) | | | |

*These samples are not according to the disclosure; comparative samples 39-41 did at least not contain a compound according to formula I.

Comparative sample 39 corresponds to solution 9 in Table 3 of US 2019/297881. According to US 2019/297881, this sample is effective against S. aureus in the ASTM E2197-02 test. However, the results in the above demonstrate that sample 16 is not effective against S. aureus when applied using a towelette in the official test required for an EPA disinfectancy claim, the Germicidal Towelette Method/AOAC Official Method 961.02.

Comparative sample 40 essentially corresponds to composition 15 of WO 2008/071746 (with EDTA instead of OctaQuest (i.e., trisodium ethylenediamine succinate) as chelating agent). According to WO 2008/071746, this sample is effective against S. aureus in the EN 1276 test. However, the results in the above demonstrate that sample sample is not effective against S. aureus when applied using a towelette in the official test required for an EPA disinfectancy claim, the Germicidal Towelette Method/AOAC Official Method 961.02.

Comparative sample 41 corresponds to the solution of Example 5 of WO 2007/080187. According to WO 2007/080187, the solution demonstrated antimicrobial activity against S. aureus in the EN 12054 test. However, the results in the above demonstrate that sample 41 is not effective against S. aureus when applied using a towelette in the official test required for an EPA disinfectancy claim, the Germicidal Towelette Method/AOAC Official Method 961.02.

Together, the results demonstrate how difficult the official EPA towelette test according to the Germicidal Towelette Method/AOAC Official Method 961.02 is to pass. It is, therefore, surprising that the disinfecting composition compositions according to the disclosure do pass this official towelette test.

### Example 5: Material Compatibility of the Disinfecting Compositions

The material compatibility of the disinfecting compositions was also evaluated. The test used evaluates the compatibility of frequent exposure to the test compositions with various materials that frequently occur in healthcare environments. 5 cm×2 cm strips of polyurethane (PU), poly(methyl metacrylate) (PMMA; Perspex), high-density polyethylene (HDPE), low-density polyethylene (LDPE), acrylonitrile butadiene styrene (ABS), acrylic polyvinyl chloride (Kydex), polypropylene (PP), polycarbonate (PC), polyethylene terephthalate (PETG), aluminium, and stainless steel 316 were used as test material.

The test strips were weighted before immersion the strips were fully immersed in the disinfecting composition. The PMMA, aluminium, and stainless steel 316 strips were not fully immersed: only ±50% of the strip surface was below the liquid surface of the test composition, causing an air-liquid interface.

After 20 hours, the test composition was removed and the strips were allowed to air dry.

After 4 hours of drying, the strips were put back in the test composition for a new 20 hour cycle. This cycle was repeated 4 times a week for 3 weeks. Every four cycles close-up pictures are taken, strips were weighted and observations were recorded. After the last cycle, the strips were cleaned with water and air dried. At the end of the test, the test strips were weighted again.

The disinfecting compositions according to the disclosure were compatible with all materials tested, even when some peracetate was present in the compositions.

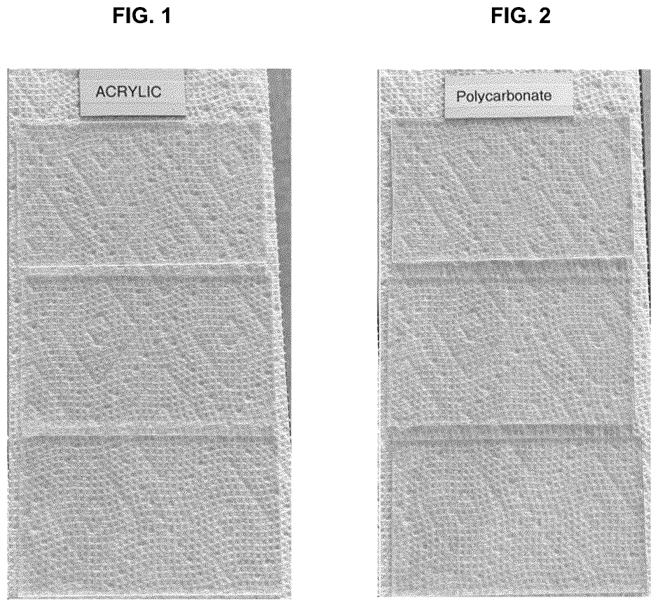

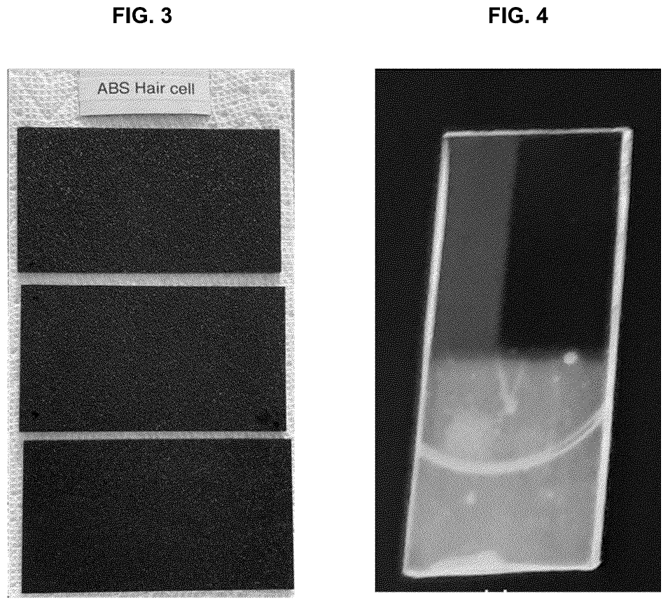

FIG. 1 shows the effect of disinfecting composition 15 on a strip of polycarbonate. FIG. 2 shows the effect of disinfecting composition 15 on a strip of acrylic. FIG. 3 shows the effect of disinfecting composition 15 on a strip of ABS. The disinfecting composition did not damage any of these materials.

The excellent material compatibility of the disinfecting compositions according to the disclosure is surprising, given that a comparative composition with good antimicrobial efficacy comprising a compound according to formula IIa, hydrogen peroxide, and benzyl alcohol as a solvent (Table 5) was found to be incompatible with many of the materials.

TABLE 5
Comparative composition for material compatibility test

| Sample no.: | 42 |
|---|---|
| Water | 91.22 |
| Monafax 1214 | 0.80 |
| Phosphoric acid | 0.55 |
| Glucopon 215 | 0.10 |
| Baypure CX100 | 0.05 |
| Interox CO-35 | 4.00 |
| Benzyl alcohol | 3.00 |
| Salicylic acid | 0.20 |
| pH | 2.5 |

For example, when this comparative composition (comparative sample 42) was evaluated, the comparative composition had a negative effect on PMMA. The PMMA test strip became soft and tacky, and its surface was completely destroyed. See FIG. 4.

### Example 6: Stability of the Disinfectant Compositions

The stability of the above mentioned disinfectant compositions according to the disclosure was evaluated using olfactory methods and is further evaluated with analytical techniques, including gas chromatography and photometric methods.

As an example, when composition 34-35 were evaluated 72 hours after they were made, no changes in composition were observed. In particular, no reaction between the compound(s) according to formula (I) and hydrogen peroxide was observed. Accordingly, the samples according to the disclosure are stable for at least 72 hours.

1. Disinfecting composition comprising:
a) one or more compounds according to formula I:
CH₃C(═O)OR¹
wherein R¹ is
C(1-5)alkoxy-C(1-5)alkyl wherein the C(1-5)alkoxy is optionally substituted with one hydroxyl group or methyl ester,
C(1-3)alkoxy-C(1-5)alkoxy-C(1-5)alkyl wherein the C(1-3)alkoxy is optionally substituted with one hydroxyl group or methyl ester,
C(2-5)alkyl wherein the C(2-5)alkyl is substituted with one or two methyl esters and/or one or two hydroxyl groups,
C(2-12)alkyl,
C(2-12)alkenyl,
C(2-12)alkynyl,
C(6)aryl-C(1-2)alkyl optionally substituted with one or more hydroxy, methoxy, amino, or C(1-3)alkyl groups,
and/or one or more compounds according to formula Ia:
R^{a}C(═O)OR^{b}
wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy,
in a total amount of from 0.1 to 20 wt. % (calculated on the total weight of the composition), optionally in a total amount of from 0.5 to 20 wt. %;
b) from 0.1 to 15 wt. % of hydrogen peroxide (calculated as the net weight of hydrogen peroxide on the total weight of the composition);
c) one or more N-acylated amino acids or salts thereof in a total amount of from 0.01 to 10 wt. % (calculated on the total weight of the composition); and
d) one or more surfactants selected from the group consisting of non-ethoxylated anionic surfactants and salts of a compound according to formula II, R²—(O—CH₂—CH₂)ₘ—O—SO₃″, wherein R² is C(8-18)alkyl and m is 2-6, in a total amount of from 0.2 to 20 wt. % (calculated on the total weight of the composition),
wherein the disinfecting composition has a pH of from 0.5 to 4.0.

2. The disinfecting composition according to claim 1, wherein the disinfecting composition comprises:
a) one or more compounds according to formula I: 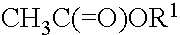
wherein R¹ is
C(1-5)alkoxy-C(1-5)alkyl wherein the C(1-5)alkoxy is optionally substituted with one hydroxyl group or methyl ester,
C(1-3)alkoxy-C(1-5)alkoxy-C(1-5)alkyl wherein the C(1-3)alkoxy is optionally substituted with one hydroxyl group or methyl ester,
C(2-5)alkyl wherein the C(2-5)alkyl is substituted with one or two methyl esters and/or one or two hydroxyl groups, or
C(2-5)alkyl,
in a total amount of from 0.1 to 20 wt. % (calculated on the total weight of the composition), optionally in a total amount of from 0.5 to 20 wt. %;
b) from 0.1 to 15 wt. % of hydrogen peroxide (calculated as the net weight of hydrogen peroxide on the total weight of the composition);
c) from 0.01 to 10 wt. % of one or more N-acylated amino acids or salts thereof (calculated on the total weight of the composition); and
d) one or more surfactants selected from the group consisting of non-ethoxylated anionic surfactants and salts of a compound according to formula II, R²—(O—CH₂—CH₂)ₘ—O—SO₃″, wherein R² is C(8-18)alkyl and m is 2-6, in a total amount of from 0.2 to 20 wt. % (calculated on the total weight of the composition),
wherein the disinfecting composition has a pH of from 0.5 to 4.0.

3. The disinfecting composition according to claim 1, wherein R¹ is
C(1-5)alkoxy-C(2-3)alkyl wherein the C(1-5)alkoxy is optionally substituted with one hydroxyl group or methyl ester,
C(1-3)alkoxy-C(2-3)alkoxy-C(2-3)alkyl wherein the C(1-3)alkoxy is optionally substituted with one hydroxyl group or methyl ester,
C(2)alkyl substituted with one hydroxyl group or one methyl ester,
C(3-5)alkyl substituted with one hydroxyl group and one methyl ester,
C(3-5)alkyl substituted with one or two hydroxyl groups, or
C(3-5)alkyl substituted with one or two methyl esters,
wherein the one or more compounds according to formula I is selected from the group consisting of propylene glycol methyl ether acetate, dipropylene glycol methyl ether acetate, triethylene glycol diacetate, tripropylene glycol diacetate, ethylene glycol diacetate, propylene glycol diacetate, 1,3-butanediol diacetate, triacetin, diacetin, monoacetin, isoamyl acetate, propyl acetate, butyl acetate, and pentyl acetate.

4. The disinfecting composition according to claim 1, wherein the composition further comprises the one or more compounds according to formula Ia.

5. The disinfecting composition according to claim 1, wherein the disinfecting composition comprises:
one or more compounds according to formula Ia: 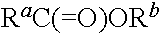
wherein R^{a} is C(6)aryl optionally substituted with hydroxyl, and R^{b} is a C(1-6)alkyl or C(6)aryl-(C1-2)alkyl,
wherein R^{a} is C(6)aryl-C(1-2)alkyl and R^{b} is C(6)aryl optionally substituted with methyl or C(1-6)alkyl optionally substituted with C(6)aryl,
wherein R^{a} is C(4-5)heteroaryl-C(1-2)alkyl and R^{b} is C(1-2)alkyl, or
wherein R^{a} is C(2-3)alkyl and R^{b} is C(6)aryl-C(1-2)alkyl optionally substituted with one or more hydroxy or methoxy,
in a total amount of from 0.1 to 20 wt. % (calculated on the total weight of the composition), optionally in a total amount of from 0.5 to 20 wt. %;
a) from 0.1 to 15 wt. % of hydrogen peroxide (calculated as the net weight of hydrogen peroxide on the total weight of the composition);
b) one or more N-acylated amino acids or salts thereof in a total amount of from 0.01 to 10 wt. % (calculated on the total weight of the composition); and
c) one or more surfactants selected from the group consisting of non-ethoxylated anionic surfactants and salts of a compound according to formula II, R²—(O—CH₂—CH₂)ₘ—O—SO₃″, wherein R² is C(8-18)alkyl and m is 2-6, in a total amount of from 0.2 to 20 wt. % (calculated on the total weight of the composition),
wherein the disinfecting composition has a pH of from 0.5 to 4.0.

6. The disinfecting composition according to claim 5, wherein the disinfecting composition comprises one or more compounds according to formula Ia, R^{a}C(═O)OR^{b}, wherein
R^{a} is C(6)aryl optionally substituted with hydroxyl, and R^{b} is a C(1-6)alkyl or C(6)aryl-(C1-2)alkyl, or
R^{a} is C(6)aryl-C(1-2)alkyl and R^{b} is C(6)aryl optionally substituted with methyl or C(1-6)alkyl optionally substituted with C(6)aryl,

7. The disinfecting composition according to claim 1, wherein the compound of formula I (a) is present in a total amount of 0.2 to 10 wt. % (calculated on the total weight of the composition); and/or
wherein the hydrogen peroxide is present in an amount of from 0.2 to 7.0 wt. % (calculated on the net weight of hydrogen peroxide based on the total weight of the composition); and/or
wherein the disinfecting composition comprises the N-acylated amino acid in an amount of from 0.05 to 7.5 wt. % of the N-acylated amino acid or salt thereof (calculated on the total weight of the composition).

8. The disinfecting composition according to claim 1, wherein the one or more N-acylated amino acids or salts thereof are selected from
N-acylated amino acids according to formula III, R³—C(═O)—N(R⁴)—(CH₂)ₙ—CH(R⁵)—C(═O)OH or a salt thereof, wherein R³—C(═O)— represents an acyl group wherein R³ is a C(5-21)alkyl radical or a C(5-21)alkylene radical, R⁴ is H or CH₃, R⁵ represents an amino acid side-chain of an amino acid selected from the group consisting of glycine and glutamine, and n is 1, and/or
N-acylated amino acids or salts thereof according to formula IIIb, R^{c}—C(═O)—N(R^{d})—(CH₂)₂—S(═O)₂OH or a salt thereof, wherein R^{c}—C(═O)— represents an acyl group wherein R^{c} is a C(5-21)alkyl radical or a C(5-21)alkylene radical and R^{d} is H, CH₃, or cyclohexyl,
wherein the N-acylated amino acid is an N-acyl sarcosine according to formula IIIa, R³—C(═O)—N(CH₃)—CH₂—C(═O)OH or a salt thereof, wherein R³ is a C(5-21)alkyl radical,
wherein the N-acylated amino acid is selected from the group consisting of N-lauroyl sarcosine, N-myristoyl sarcosine, N-cocoyl sarcosine, N-oleoyl sarcosine, N-stearoyl sarcosine, sodium lauroyl sarcosinate, sodium myristoyl sarcosinate, sodium cocoyl sarcosinate, sodium oleoyl sarcosinate, and sodium stearoyl sarcosinate.

9. The disinfecting composition according to claim 1, wherein the disinfecting composition comprises one or more non-ethoxylated anionic surfactants or salts thereof.

10. The disinfecting composition according to claim 1, wherein the disinfecting composition further comprises a percarboxylic acid or a precursor thereof.

11. The disinfecting composition according to claim 1, wherein the disinfecting composition has a pH of from 1.0 to 3.0.

12. The disinfecting composition according to claim 1, wherein the disinfecting composition comprises less than 0.1 wt. % of an amine oxide surfactant according to the formula R⁷R⁸R⁹N⁺O⁻, wherein R⁷ contains 8-18 carbon atoms and R⁸ and R⁹ each contain 1-4 carbon atoms (calculated on the total weight of the composition).

13. The disinfecting composition according to claim 1, wherein the disinfecting composition comprises less than 3.0 wt. % of benzyl alcohol (calculated on the total weight of the composition).

14. The disinfecting composition according to claim 1, wherein the disinfecting composition is suitable for disinfecting a surface (suspected of being) infected with a bacterium and/or a non-enveloped virus.

15. The disinfecting composition according to claim 1, wherein the disinfecting composition comprises less than 0.1 wt. % of a perhydrolase (calculated on the total weight of the composition); and/or
wherein the disinfecting composition comprises less than 0.1 wt. % of a C3-C6 N-alkyl-gamma-butyrolactam (calculated on the total weight of the composition).

16. The disinfecting composition according to claim 1, wherein the disinfecting composition comprises
a) one or more compounds according to formula I, CH₃C(═O)OR¹, wherein R¹ is
C(1-5)alkoxy-C(2-3)alkyl wherein the C(1-5)alkoxy is optionally substituted with one hydroxyl group or methyl ester,
C(1-3)alkoxy-C(2-3)alkoxy-C(2-3)alkyl wherein the C(1-3)alkoxy is optionally substituted with one hydroxyl group or methyl ester,
C(2)alkyl substituted with one hydroxyl group or one methyl ester,
C(3-5)alkyl substituted with one hydroxyl group and one methyl ester,
C(3-5)alkyl substituted with one or two hydroxyl groups, or
C(3-5)alkyl substituted with one or two methyl esters,
in a total amount of from 1.0 to 10.0 wt. % (calculated on the total weight of the composition);
b) from 0.2 to 7.0 wt. % of hydrogen peroxide (calculated as the net weight of hydrogen peroxide on the total weight of the composition);
c) from 0.01 to 10 wt. % of one or more N-acylated amino acids, or a salt thereof;
d) one or more non-ethoxylated anionic surfactants in a total amount of from 0.2 to 20 wt. % (calculated on the total weight of the composition),
e) from 0.01 to 2.0 wt. % of a hydrogen peroxide stabilizer (calculated on the total weight of the composition);
f) from 0.1 to 2.0 wt. % of one or more acids; and
wherein the disinfecting composition has a pH of from 1.5 to 3.0, and
wherein the disinfecting composition comprises a percarboxylic acid or a precursor thereof.

17. Towelette comprising the disinfecting composition according to claim 1.

18. The method of disinfecting a surface comprising applying the disinfecting composition according to claim 1 to the surface.

19. The method according to claim 18, wherein the surface comprises a material selected from the group of polyurethane (PU), poly(methyl metacrylate) (PMMA; Perspex), high-density polyethylene, low-density polyethylene, acrylonitrile butadiene styrene (ABS), acrylic polyvinyl chloride, polypropylene (PP), polycarbonate (PC), polyethylene terephthalate (PETG), aluminium, and stainless steel.
